(19) United States
(12) Patent Application Publication
(10) Pub. No.: US 2013/0163790 A1
(43) Pub. Date: Jun. 27, 2013

(54) MICROPHONE UNIT AND ELECTRONIC APPARATUS

(71) Applicants: Funai Electric Co., Ltd., Osaka (JP); Funai Electric Advanced Applied Technology Research Institute Inc., Osaka (JP)

(72) Inventors: Noriyuki Shimizu, Osaka (JP); Fuminori Tanaka, Osaka (JP); Naoya Uehigashi, Osaka (JP); Masatoshi Ono, Osaka (JP)

(73) Assignees: Funai Electric Advanced Applied Technology Research Institute Inc., Osaka (JP); FUNAI ELECTRIC CO., LTD., Osaka (JP)

(21) Appl. No.: 13/720,126

(22) Filed: Dec. 19, 2012

(30) Foreign Application Priority Data
Dec. 27, 2011 (JP) 2011-286545

(51) Int. Cl. H04R 3/00

(52) U.S. Cl. CPC H04R 3/00
USPC 381/122

(57) ABSTRACT

In this microphone unit, a first sound hole and a second sound hole are provided to extend toward a surface of an electronic apparatus internally mounted with a differential vibrating portion, intersecting with a main surface of the electronic apparatus, and an end portion of the first sound hole closer to the surface intersecting with the main surface of the electronic apparatus and an end portion of the second sound hole closer to the surface intersecting with the main surface of the electronic apparatus are so arranged that the vertical distances of the end portions from the main surface of the electronic apparatus are different from each other.

### BACKGROUND OF THE INVENTION

1. Field of the Invention

The present invention relates to a microphone unit and an electronic apparatus, and more particularly, it relates to a microphone unit mounted on an electronic apparatus and an electronic apparatus mounted with a microphone unit.

2. Description of the Background Art

A microphone unit mounted on an electronic apparatus is known in general, as disclosed in Japanese Patent Laying-Open No. 2001-217627, for example.

The aforementioned Japanese Patent Laying-Open No. 2001-217627 discloses a microphone unit internally mounted on a portable telephone. This microphone unit is mounted on a circuit board arranged parallel to a main surface of the portable telephone provided with operation keys including number buttons etc. and a display portion. A transmission portion (opening) to guide sound waves to the microphone unit is formed in a position of the main surface of the portable telephone corresponding to the microphone unit.

Furthermore, a microphone unit including a bidirectional differential vibrating portion is known in general, as disclosed in Japanese Patent Laying-Open No. 2005-295278, for example.

The aforementioned Japanese Patent Laying-Open No. 2005-295278 discloses a microphone unit including a bidirectional microphone (differential vibrating portion) acquiring an acoustic signal on the basis of a difference between sound pressures arriving through the respective ones of two sound holes.

In order to remove the noise of voice detected by the microphone unit, the microphone unit including the bidirectional differential vibrating portion according to the aforementioned Japanese Patent Laying-Open No. 2005-295278 is conceivably mounted on an electronic apparatus such as a portable telephone. In this case, the microphone unit including the bidirectional differential vibrating portion is conceivably arranged on a position of a circuit board arranged parallel to a main surface of the portable telephone, corresponding to a transmission portion (opening) formed in the main surface of the portable telephone (electronic apparatus), similarly to the microphone unit according to the aforementioned Japanese Patent Laying-Open No. 2001-217627.

In the aforementioned structure in which the microphone unit including the bidirectional differential vibrating portion is arranged on the position of the circuit board corresponding to the transmission portion (opening) formed in the main surface of the portable telephone (electronic apparatus), however, sound waves are guided to the bidirectional differential vibrating portion through the transmission portion (opening) formed in the main surface of the portable telephone, so that two voice detectable regions of a figure-eight directivity pattern are arranged adjacent to each other along the main surface of the portable telephone. In other words, a Null region, which is a region where voice cannot be detected, located between the two voice detectable regions disadvantageously faces the main surface of the portable telephone. Therefore, according to the aforementioned structure, voice output from a sound source located on the main surface side of the portable telephone (electronic apparatus) may not be capable of being accurately detected.

### SUMMARY OF THE INVENTION

The present invention has been proposed in order to solve the aforementioned problem, and an object of the present invention is to provide a microphone unit capable of accurately detecting voice output from a sound source located on the main surface side of an electronic apparatus while removing noise and an electronic apparatus including such a microphone unit.

A microphone unit according to a first aspect of the present invention includes a differential vibrating portion detecting a sound wave on the basis of a difference between a sound pressure arriving through a first sound hole and a sound pressure arriving through a second sound hole, while the first sound hole and the second sound hole are provided to extend toward a surface of an electronic apparatus internally mounted with the differential vibrating portion, intersecting with a main surface of the electronic apparatus, and an end portion of the first sound hole closer to the surface intersecting with the main surface of the electronic apparatus and an end portion of the second sound hole closer to the surface intersecting with the main surface of the electronic apparatus are so arranged that the vertical distances of the end portions from the main surface of the electronic apparatus are different from each other. The main surface of the electronic apparatus denotes a surface on which a display portion and a main operation portion of the electronic apparatus are arranged. Furthermore, the surface intersecting with the main surface is not restricted to a surface formed by bending from the main surface, but it is directed to a wide concept also including a surface continuously formed in a curved manner from the main surface.

In the microphone unit according to the first aspect of the present invention, as hereinabove described, the first sound hole and the second sound hole each guiding sound waves to the differential vibrating portion are provided to extend toward the surface intersecting with the main surface of the electronic apparatus internally mounted with the differential vibrating portion, and the end portion of the first sound hole closer to the surface intersecting with the main surface of the electronic apparatus and the end portion of the second sound hole closer to the surface intersecting with the main surface of the electronic apparatus are so arranged that the vertical distances thereof from the main surface of the electronic apparatus are different from each other, whereby two voice detectable regions of a figure-eight directivity pattern can be arranged adjacent to each other in a direction intersecting with the main surface of the electronic apparatus. Thus, a Null region can be spread on the side of the surface intersecting with the main surface of the electronic apparatus while being inhibited from being spread on the main surface side of the electronic apparatus. Consequently, voice output from a sound source located on the main surface side of the electronic apparatus can be accurately detected while noise on the side of the surface intersecting with the main surface of the electronic apparatus is removed.

In the aforementioned microphone unit according to the first aspect, the first sound hole and the second sound hole are preferably provided to extend toward the common surface intersecting with the main surface of the electronic apparatus. According to this structure, the end portion of the first sound hole and the end portion of the second sound hole can be easily put close to each other, and hence the first sound hole and the second sound hole can be arranged in a smaller arrangement space.

In the aforementioned microphone unit according to the first aspect, the end portion of the first sound hole and the end portion of the second sound hole are preferably spaced from each other on the same axis line substantially orthogonal to the main surface of the electronic apparatus. According to this structure, the two voice detectable regions of a figure-eight directivity pattern can be arranged adjacent to each other in a direction substantially orthogonal to the main surface of the electronic apparatus, and hence the Null region can be further inhibited from being spread on the main surface side of the electronic apparatus. Consequently, the voice output from the sound source located on the main surface side of the electronic apparatus can be more accurately detected.

The aforementioned microphone unit according to the first aspect preferably further includes an omnidirectional vibrating portion detecting a sound wave arriving through the second sound hole, and the end portion of the second sound hole is preferably so arranged that the vertical distance of the end portion of the second sound hole from the main surface of the electronic apparatus is larger than the vertical distance of the end portion of the first sound hole from the main surface of the electronic apparatus. According to this structure, the second sound hole guiding sound waves to the omnidirectional vibrating portion having sensitivity higher than that of the differential vibrating portion is further distanced from the main surface of the electronic apparatus than the first sound hole, and hence a difference between the sensitivity of the differential vibrating portion and the sensitivity of the omnidirectional vibrating portion with respect to the voice output from the sound source located on the main surface side of the electronic apparatus can be reduced. Consequently, the voice can be detected by the differential vibrating portion and the omnidirectional vibrating portion in a balanced manner.

In the aforementioned microphone unit according to the first aspect, the first sound hole preferably includes a first internal sound hole and a first external sound hole connected to the first internal sound hole and the second sound hole preferably includes a second internal sound hole and a second external sound hole connected to the second internal sound hole, while the microphone unit preferably further includes a microphone unit body provided with the differential vibrating portion and the first and second internal sound holes and the first external sound hole and the second external sound hole are preferably provided to extend from the first internal sound hole and the second internal sound hole, respectively, toward the surface intersecting with the main surface of the electronic apparatus. According to this structure, sound waves guided to the differential vibrating portion provided in the microphone unit body through the first internal sound hole and the second internal sound hole can be easily taken from the surface intersecting with the main surface of the electronic apparatus through the first external sound hole and the second external sound hole, respectively.

In this case, the surface intersecting with the main surface of the electronic apparatus is preferably formed to be substantially orthogonal to the main surface, both an end portion of the first internal sound hole closer to the first external sound hole and an end portion of the second internal sound hole closer to the second external sound hole are preferably provided in a surface of the microphone unit body arranged substantially parallel to the main surface of the electronic apparatus, and the first external sound hole and the second external sound hole are preferably provided to extend from the first internal sound hole and the second internal sound hole, respectively, toward the surface substantially orthogonal to the main surface of the electronic apparatus by bending or curving. According to this structure, the first external sound hole and the second external sound hole are provided to extend in a direction substantially orthogonal to the surface of the microphone unit body provided with the respective end portions of the first internal sound hole and the second internal sound hole, and hence sound waves can be easily taken from the direction substantially orthogonal to the surface of the microphone unit body provided with the respective end portions of the first internal sound hole and the second internal sound hole.

In the aforementioned structure in which each of the first external sound hole and the second external sound hole is bent or curved, the microphone unit preferably further includes a sound hole forming member formed with the first external sound hole and the second external sound hole, and the first external sound hole and the second external sound hole are preferably provided to extend from one of two surfaces, substantially orthogonal to each other, of the sound hole forming member toward the other, so that the first external sound hole and the second external sound hole extend toward the surface intersecting with the main surface of the electronic apparatus. According to this structure, the traveling directions of sound waves are bent in a substantially orthogonal direction by the first external sound hole and the second external sound hole formed in the sound hole forming member, and hence sound waves can be more easily taken from the direction substantially orthogonal to the surface of the microphone unit body provided with the respective end portions of the first internal sound hole and the second internal sound hole.

In the aforementioned structure provided with the first external sound hole and the second external sound hole, the first external sound hole and the second external sound hole preferably have cross-sectional shapes substantially identical to each other in directions substantially orthogonal to the traveling directions of sound waves. According to this structure, a difference between the ease (difficulty) of passage of sound waves through the first external sound hole and the ease (difficulty) of passage of sound waves through the second external sound hole can be reduced, and hence sound waves arriving through the respective ones of the first external sound hole and the second external sound hole can be detected by the differential vibrating portion in a balanced manner. Consequently, the accuracy of detecting voice can be improved.

In the aforementioned structure provided with the first external sound hole and the second external sound hole, the first external sound hole and the second external sound hole preferably have lengths substantially equal to each other. According to this structure, a difference between the attenuation of sound waves passing through the first external sound hole and the attenuation of sound waves passing through the second external sound hole can be reduced, and hence the sound waves arriving through the respective ones of the first external sound hole and the second external sound hole can be detected by the differential vibrating portion in a balanced manner. Consequently, the accuracy of detecting voice can be improved.

In the aforementioned structure provided with the first external sound hole and the second external sound hole, a first end portion of the first external sound hole closer to the surface intersecting with the main surface of the electronic apparatus and a first end portion of the second external sound hole closer to the surface intersecting with the main surface of the electronic apparatus are preferably separately arranged at a distance, which is smaller than a distance between a second end portion of the first external sound hole connected to the first internal sound hole and a second end portion of the second external sound hole connected to the second internal sound hole, from each other. According to this structure, the distance between the first end portion of the first external sound hole and the first end portion of the second external sound hole can be rendered smaller, and hence increase in the thickness of the electronic apparatus in the direction intersecting with the main surface, resulting from the arrangement of the first external sound hole and the second external sound hole can be suppressed. Consequently, the thickness of the electronic apparatus can be reduced.

In the aforementioned structure in which each of the first external sound hole and the second external sound hole is bent or curved, the first external sound hole and the second external sound hole respectively are preferably so formed that the vicinity of an end portion of the first external sound hole closer to the first internal sound hole and the vicinity of an end portion of the second external sound hole closer to the second internal sound hole are substantially orthogonal to the surface of the microphone unit body arranged substantially parallel to the main surface of the electronic apparatus, which is provided with the end portion of the first internal sound hole closer to the first external sound hole and the end portion of the second internal sound hole closer to the second external sound hole. According to this structure, through the first external sound hole and the second external sound hole, the traveling directions of sound waves face the direction substantially orthogonal to the surface of the microphone unit body provided with the end portion of the first internal sound hole closer to the first external sound hole and the end portion of the second internal sound hole closer to the second external sound hole in the vicinity of the first internal sound hole and the second internal sound hole, respectively, and hence sound waves can be easily taken into the microphone unit body.

In the aforementioned structure provided with the first external sound hole and the second external sound hole, an end portion of the first internal sound hole closer to the first external sound hole and an end portion of the second internal sound hole closer to the second external sound hole preferably have opening areas larger than opening areas of an end portion of the first external sound hole closer to the first internal sound hole and an end portion of the second external sound hole closer to the second internal sound hole, respectively. According to this structure, sound waves guided through the first external sound hole and the second external sound hole can be reliably taken from the first internal sound hole and the second internal sound hole into the microphone unit body, respectively.

In the aforementioned structure provided with the first external sound hole and the second external sound hole, the first internal sound hole and the second internal sound hole are preferably connected to the first external sound hole and the second external sound hole through a sound leakage prevention member, respectively. According to this structure, sound leakage from a connection portion between the first internal sound hole and the first external sound hole and a connection portion between the second internal sound hole and the second external sound hole can be prevented by the sound leakage prevention member, and hence sound waves can be efficiently taken into the microphone unit body.

In the aforementioned microphone unit according to the first aspect, the main surface of the electronic apparatus is preferably a surface arranged substantially parallel to a main surface of a substrate mounted with the differential vibrating portion. According to this structure, sound waves taken from a surface intersecting with the main surface of the substrate can be guided to the differential vibrating portion by the first sound hole and the second sound hole.

The aforementioned microphone unit according to the first aspect is preferably a MEMS microphone. If the microphone unit according to the first aspect is applied to the MEMS microphone, the voice output from the sound source located on the main surface side of the electronic apparatus can be accurately detected while the noise on the side of the surface intersecting with the main surface of the electronic apparatus is removed in the small-sized electronic apparatus such as a portable telephone.

An electronic apparatus according to a second aspect of the present invention includes a differential vibrating portion detecting a sound wave on the basis of a difference between a sound pressure arriving through a first sound hole and a sound pressure arriving through a second sound hole and an electronic apparatus housing which houses the differential vibrating portion, while the first sound hole and the second sound hole are provided to extend toward a surface of the electronic apparatus housing intersecting with a main surface of the electronic apparatus housing, and an end portion of the first sound hole closer to the surface intersecting with the main surface of the electronic apparatus housing and an end portion of the second sound hole closer to the surface intersecting with the main surface of the electronic apparatus housing are so arranged that the vertical distances of the end portions from the main surface of the electronic apparatus housing are different from each other.

In the electronic apparatus according to the second aspect of the present invention, as hereinabove described, the first sound hole and the second sound hole each guiding sound waves to the differential vibrating portion are provided to extend toward the surface intersecting with the main surface of the electronic apparatus housing, and the end portion of the first sound hole closer to the surface intersecting with the main surface of the electronic apparatus housing and the end portion of the second sound hole closer to the surface intersecting with the main surface of the electronic apparatus housing are so arranged that the vertical distances thereof from the main surface of the electronic apparatus housing are different from each other, whereby two voice detectable regions of a figure-eight directivity pattern can be arranged adjacent to each other in a direction intersecting with the main surface of the electronic apparatus housing. Thus, a Null region can be spread on the side of the surface intersecting with the main surface of the electronic apparatus housing while being inhibited from being spread on the main surface side of the electronic apparatus housing. Consequently, voice output from a sound source located on the main surface side of the electronic apparatus housing can be accurately detected while noise on the side of the surface intersecting with the main surface of the electronic apparatus housing is removed. As to the electronic apparatus such as a portable telephone, the sound source (user's mouth) is usually located on the main surface side, and hence the present invention is particularly effective.

In the aforementioned electronic apparatus according to the second aspect, a first opening and a second opening corresponding to the end portion of the first sound hole and the end portion of the second sound hole, respectively, are preferably formed in the surface intersecting with the main surface of the electronic apparatus housing. According to this structure, sound waves can be easily taken from the outside of the electronic apparatus housing into the first sound hole and the second sound hole through the first and second openings formed in the electronic apparatus housing, respectively.

In the aforementioned electronic apparatus according to the second aspect, the electronic apparatus housing preferably has a flat rectangular parallelepiped shape, and the main surface is preferably provided to be substantially orthogonal to a thickness direction of the electronic apparatus housing. According to this structure, in the electronic apparatus having the flat electronic apparatus housing, such as a portable telephone, the Null region can be inhibited from being spread on the side of the main surface substantially orthogonal to the thickness direction of the electronic apparatus housing, and hence the voice output from the sound source located on the main surface side of the electronic apparatus housing can be accurately detected.

In the aforementioned electronic apparatus according to the second aspect, the first sound hole and the second sound hole are preferably provided to extend toward the common surface intersecting with the main surface of the electronic apparatus housing. According to this structure, the end portion of the first sound hole and the end portion of the second sound hole can be easily put close to each other, and hence the first sound hole and the second sound hole can be arranged in a smaller arrangement space.

In the aforementioned electronic apparatus according to the second aspect, the end portion of the first sound hole and the end portion of the second sound hole are preferably spaced from each other on the same axis line substantially orthogonal to the main surface of the electronic apparatus housing. According to this structure, the two voice detectable regions of a figure-eight directivity pattern can be arranged adjacent to each other in a direction substantially orthogonal to the main surface of the electronic apparatus housing, and hence the Null region can be further inhibited from being spread on the main surface side of the electronic apparatus housing. Consequently, the voice output from the sound source located on the main surface side of the electronic apparatus housing can be more accurately detected.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of a portable telephone according to a first embodiment of the present invention;

FIG. 2 is an exploded perspective view showing the overall structure of a MEMS microphone of the portable telephone according to the first embodiment of the present invention;

FIG. 3 is a perspective view showing a microphone unit body of the portable telephone according to the first embodiment of the present invention;

FIG. 4 is an exploded perspective view showing the microphone unit body of the portable telephone according to the first embodiment of the present invention;

FIG. 5 is a sectional view of the microphone unit body of the portable telephone according to the first embodiment of the present invention, as viewed from a Y1 side;

FIG. 6 is a plan view showing a first substrate layer of the microphone unit body of the portable telephone according to the first embodiment of the present invention;

FIG. 7 is a plan view showing a second substrate layer of the microphone unit body of the portable telephone according to the first embodiment of the present invention;

FIG. 8 is a plan view showing a third substrate layer of the microphone unit body of the portable telephone according to the first embodiment of the present invention;

FIG. 9 is a plan view showing the MEMS microphone of the portable telephone according to the first embodiment of the present invention;

FIG. 10 is a side elevational view showing the MEMS microphone of the portable telephone according to the first embodiment of the present invention;

FIG. 11 illustrates the MEMS microphone of the portable telephone according to the first embodiment of the present invention, as viewed from a Y2 side;

FIG. 12 illustrates a state where a user holds the portable telephone according to the first embodiment of the present invention up to the side of his/her face while aligning his/her ear with the portable telephone;

FIG. 13 illustrates a state where the user holds the portable telephone according to the first embodiment of the present invention up to the front side of his/her face;

FIG. 14 illustrates a state where the user holds a portable telephone according to a comparative example up to the side of his/her face while aligning his/her ear with the portable telephone;

FIG. 15 illustrates a state where the user holds the portable telephone according to the comparative example up to the front side of his/her face;

FIG. 16 is a side elevational view showing a MEMS microphone of a portable telephone according to a second embodiment of the present invention;

FIG. 17 is an exploded perspective view showing a microphone unit body of the portable telephone according to the second embodiment of the present invention;

FIG. 18 is a sectional view of the microphone unit body of the portable telephone according to the second embodiment of the present invention, as viewed from a Y1 side;

FIG. 19 is a plan view showing a first substrate layer of the microphone unit body of the portable telephone according to the second embodiment of the present invention;

FIG. 20 is a plan view showing a second substrate layer of the microphone unit body of the portable telephone according to the second embodiment of the present invention;

FIG. 21 is a plan view showing a third substrate layer of the microphone unit body of the portable telephone according to the second embodiment of the present invention;

FIG. 22 illustrates a portable telephone according to a first modification of the first embodiment of the present invention;

FIG. 23 illustrates a portable telephone according to a second modification of the first embodiment of the present invention;

FIG. 24 illustrates a portable telephone according to a third modification of the first embodiment of the present invention;

FIG. 25 illustrates a portable telephone according to a fourth modification of the first embodiment of the present invention;

FIG. 26 illustrates a portable telephone according to a fifth modification of the first embodiment of the present invention;

FIG. 27 illustrates a case where the length of an outer housing of the portable telephone according to the fifth modification of the first embodiment of the present invention is short;

FIG. 28 illustrates a case where the length of the outer housing of the portable telephone according to the fifth modification of the first embodiment of the present invention is long;

FIG. 29 illustrates a portable telephone according to a sixth modification of the first embodiment of the present invention;

FIG. 30 illustrates a portable telephone according to a seventh modification of the first embodiment of the present invention;

FIG. 31 is a side elevational view showing a portable telephone according to a modification of the second embodiment of the present invention;

FIG. 32 is a perspective view showing the portable telephone according to the modification of the second embodiment of the present invention;

FIG. 33 illustrates a portable telephone according to an eighth modification of the first embodiment of the present invention; and

FIG. 34 illustrates a portable telephone according to a ninth modification of the first embodiment of the present invention.

### DESCRIPTION OF THE PREFERRED EMBODIMENTS

Embodiments of the present invention are now described with reference to the drawings.

### First Embodiment

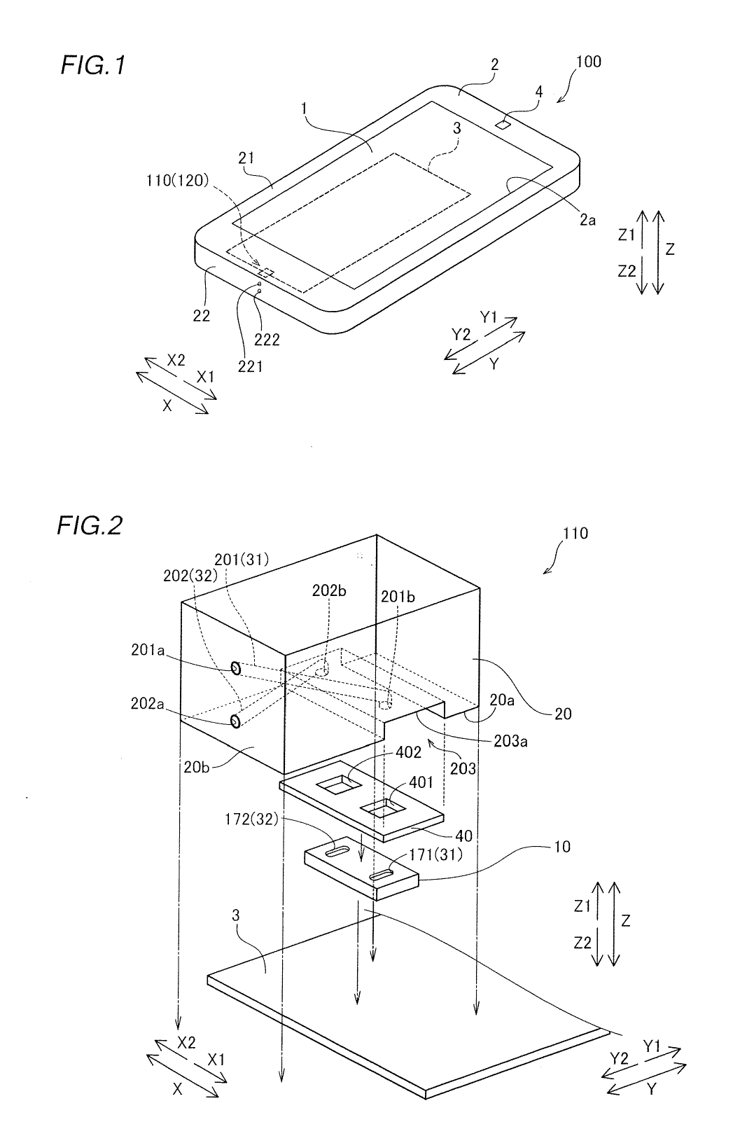

First, the structure of a portable telephone 100 according to a first embodiment of the present invention is described with reference to FIGS. 1 to 11. The portable telephone 100 is an example of the “electronic apparatus” in the present invention.

The portable telephone 100 according to the first embodiment of the present invention includes a display portion 1 and an outer housing 2 having an opening portion 2a exposing the display portion 1, as shown in FIG. 1. A substrate 3 mounted with a MEMS (Micro Electro Mechanical Systems) microphone 110 is provided in the outer housing 2. The MEMS microphone 110 is an example of the “microphone unit” in the present invention. The outer housing 2 is an example of the “electronic apparatus housing” in the present invention.

The outer housing 2 has a flat, substantially rectangular parallelepiped shape. The display portion 1 is provided on a main surface 21 orthogonal to the thickness direction (direction Z) of the outer housing 2. A speaker 4 is provided on the main surface 21. The substrate 3 is arranged on the rear surface side (Z2 side) of the display portion 1 and parallel to the main surface 21. In other words, the main surface 21 of the outer housing 2 is arranged parallel to a main surface of the substrate 3. Circular first opening 211 and second opening 222 are formed in a side surface 22 on a Y2 side, orthogonal to the main surface 21 of the outer housing 2.

Next, the structure of the MEMS microphone 110 according to the first embodiment is described in detail. The MEMS microphone 110 includes a microphone unit body 10 and a sound hole forming member 20, as shown in FIG. 2. The MEMS microphone 110 is mounted on the upper surface (surface on a Z1 side) of the substrate 3 in a state where the microphone unit body 10 and the sound hole forming member 20 are vertically stacked through a gasket 40. The microphone unit body 10 is provided with two sound holes (a first internal sound hole 171 and a second internal sound hole 172), and the sound hole forming member 20 is provided with a first external sound hole 201 and a second external sound hole 202 corresponding to the respective ones of these sound holes. As shown in FIG. 2, the first internal sound hole 171 and the first external sound hole 201 constitute a first sound hole 31 extending toward the side surface 22 (see FIG. 1) of the outer housing 2. The second internal sound hole 172 and the second external sound hole 202 constitute a second sound hole 32 extending toward the side surface 22 (see FIG. 1) of the outer housing 2.

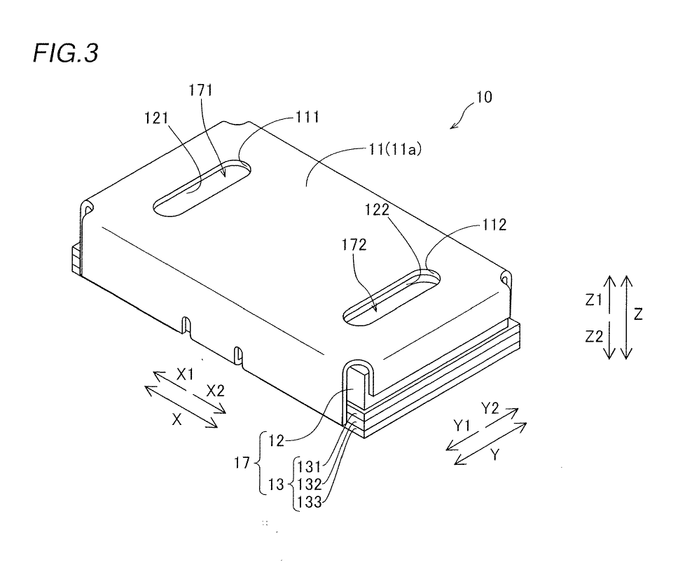

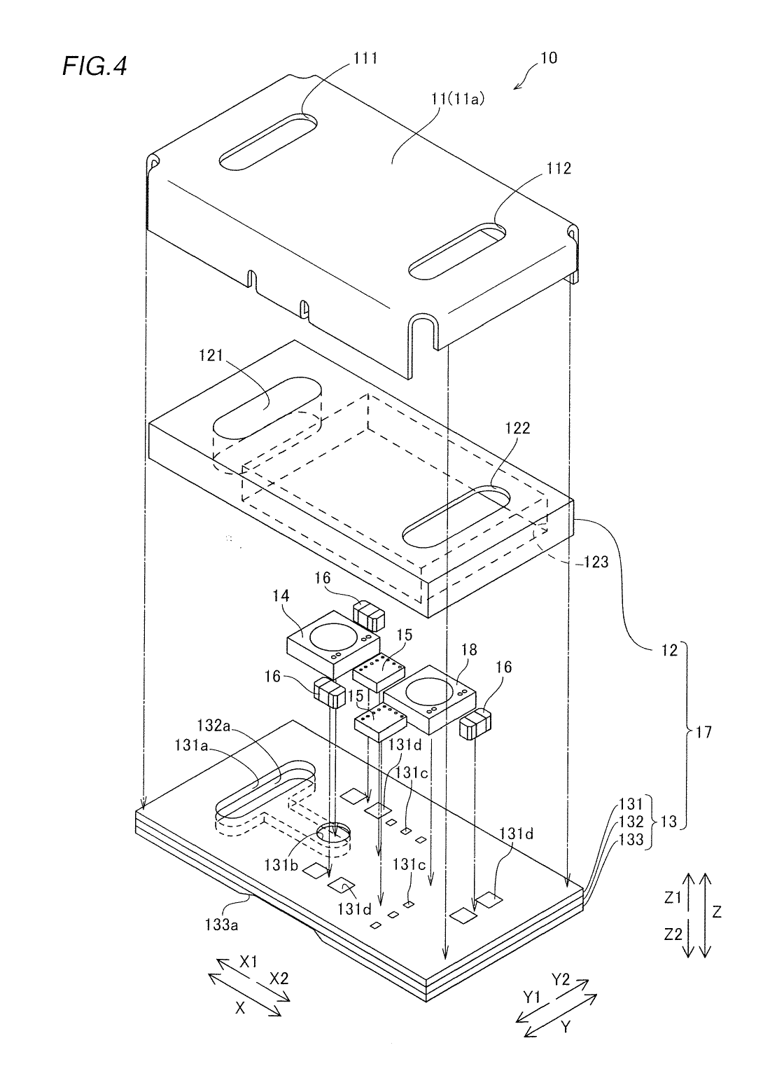

The microphone unit body 10 includes a shield 11, a cover substrate 12, and a base substrate 13, as shown in FIGS. 3 and 4. The base substrate 13 of the microphone unit body 10 is mounted with a differential vibrating portion 14, a plurality of circuit portions 15, and a plurality of chip capacitors 16, as shown in FIG. 4. The cover substrate 12 and the base substrate 13 constitute a microphone housing 17 housing the differential vibrating portion 14, the circuit portions 15, and the chip capacitors 16. According to the first embodiment, the microphone unit body 10 further includes an omnidirectional vibrating portion 18 in addition to the differential vibrating portion 14. The omnidirectional vibrating portion 18 is arranged on the X2 side of the differential vibrating portion 14, and is housed in the microphone housing 17. The plurality of circuit portions 15 and the plurality of chip capacitors 16 are provided to correspond to the differential vibrating portion 14 and the omnidirectional vibrating portion 18.

The microphone unit body 10 functions as a bidirectional (substantially figure-eight directivity pattern) differential microphone having a Null region where sounds cannot be detected by transmitting sound waves to the differential vibrating portion 14 through the two sound holes (the first internal sound hole 171 and the second internal sound hole 172), and functions as an omnidirectional microphone capable of evenly picking up sounds over the entire range by transmitting sound waves to the omnidirectional vibrating portion 18 through the single sound hole (second internal sound hole 172). The microphone unit body 10 according to the first embodiment has a length (length in a direction X) of about 7 mm, a width (length in a direction Y) of about 4 mm, and a thickness (length in the direction Z) of about 1.2 mm, for example.

The shield 11 is configured to cover the microphone housing 17 from the side of the cover substrate 12, as shown in FIGS. 3 and 4. The shield 11 is made of metal (nickel silver, for example), and is provided to prevent electrical noise. Two sound holes 111 and 112 constituting the first internal sound hole 171 and the second internal sound hole 172, respectively, are formed in an upper surface portion 11a of the shield 11. The two sound holes 111 and 112 are formed to pass through the upper surface portion 11a of the shield 11 vertically (in the direction Z). The sound holes 111 and 112 are in the form of a track (elliptical shape) having a longitudinal length of about 2.65 mm and a short-side length of about 0.6 mm in a plan view. Furthermore, the sound holes 111 and 112 are arranged at a center-to-center distance D1 (see FIG. 9) (5 mm, for example) in the direction X from each other.

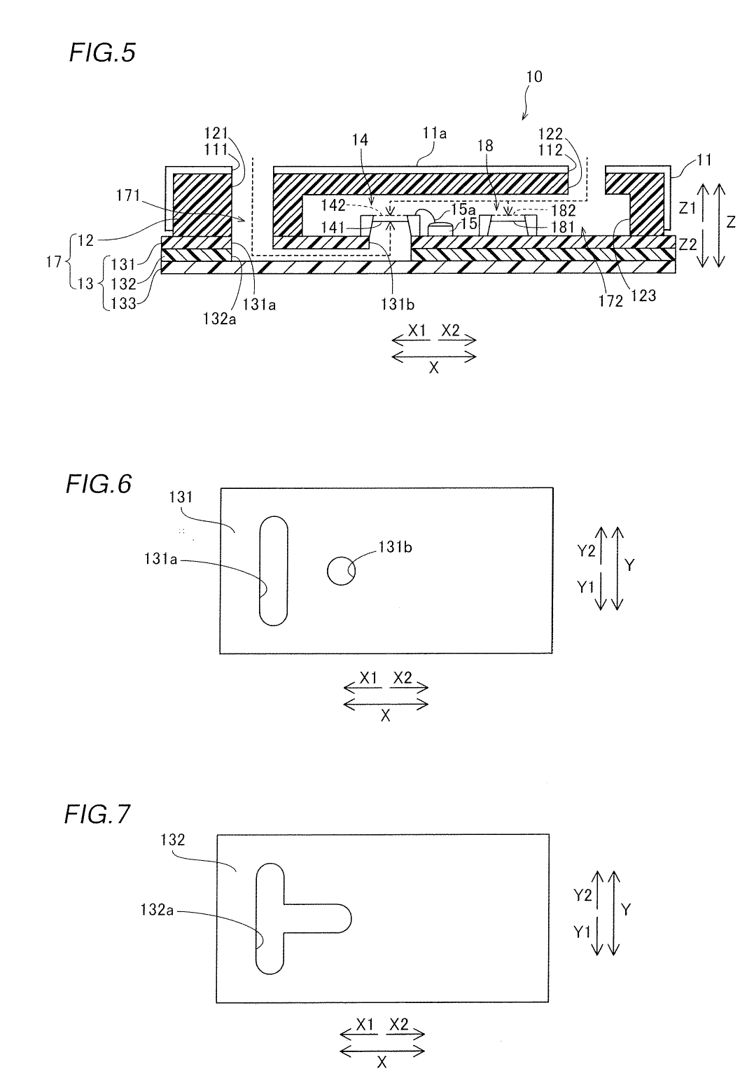

The cover substrate 12 is made of glass epoxy resin such as FR-4 (Flame Retardant Type 4). The cover substrate 12 is arranged to be held between the shield 11 and the base substrate 13. Furthermore, the cover substrate 12 is formed with two sound holes 121 and 122 corresponding to the two sound holes 111 and 112 of the shield 11, respectively, as shown in FIGS. 3 to 5. As shown in FIGS. 4 and 5, the cover substrate 12 is formed with a recess portion 123 housing the differential vibrating portion 14, the circuit portions 15, the chip capacitors 16 (see FIG. 4), and the omnidirectional vibrating portion 18. The cover substrate 12 is provided to cover the differential vibrating portion 14 and the omnidirectional vibrating portion 18.

The sound hole 122 and the recess portion 123 are connected to each other. The sound hole 121 is formed to pass through the cover substrate 12 vertically (in the direction Z). The sound holes 121 and 122 are in the form of a track having a longitudinal length of about 2.65 mm and a short-side length of about 0.6 mm in a plan view. Furthermore, the sound holes 121 and 122 are arranged at a center-to-center distance D1 (see FIG. 9) (5 mm, for example) in the direction X from each other.

The base substrate 13 is made of glass epoxy resin such as FR-4, similarly to the cover substrate 12. Thus, the coefficients of thermal expansion of the cover substrate 12 and the base substrate 13 can be rendered equal to each other, and hence separation of the cover substrate 12 and the base substrate 13 from each other resulting from a difference between the coefficients of thermal expansion of the cover substrate 12 and the base substrate 13 can be prevented when the microphone unit body 10 is reflow-mounted. The base substrate 13 has a three-layer structure of first, second, and third substrate layers 131, 132, and 133, as shown in FIGS. 3 to 5. Specifically, the first substrate layer 131, the second substrate layer 132, and the third substrate layer 133 are bonded to each other by unshown bonding sheets.

The first substrate layer 131 is formed with a sound hole 131a in the form of a track (elliptical shape) corresponding to the sound hole 121 of the cover substrate 12 and a circular sound hole 131b spaced in the direction X from the sound hole 131a, as shown in FIGS. 4 to 6. As shown in FIG. 4, bonding pads 131c and pads 131d are provided on the upper surface (surface on the Z1 side) of the first substrate layer 131.

The sound hole 131a of the first substrate layer 131 has a longitudinal length of about 2.65 mm and a short-side length of about 0.6 mm, similarly to the sound hole 121 of the cover substrate 12. The sound hole 131b of the first substrate layer 131 has a diameter of about 0.6 mm. The sound hole 131b is so configured that the upper side (Z1 side) thereof is covered with the differential vibrating portion 14.

The bonding pads 131c are provided to connect the base substrate 13 and the circuit portions 15 to each other through unshown bonding wires, as shown in FIG. 4. The pads 131d are provided to connect the base substrate 13 and the chip capacitors 16 to each other by solder. The bonding pads 131c and the pads 131d are connected to electrode pads (not shown) arranged on the lower surface (surface on the Z2 side) of the third substrate layer 133 through unshown circuit patterns and unshown through-holes.

The second substrate layer 132 is formed with a hollow portion 132a causing the sound holes 131a and 131b of the first substrate layer 131 to communicate with each other, as shown in FIGS. 4, 5, and 7. The hollow portion 132a is T-shaped in a plan view.

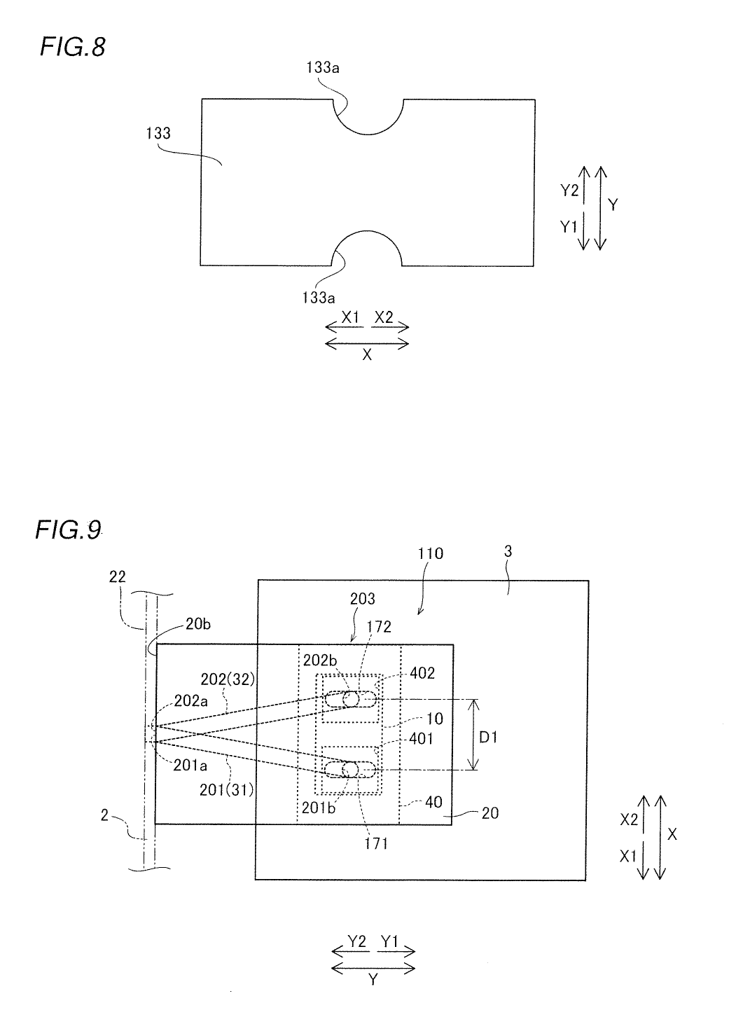

The unshown four electrode pads are provided on the lower surface (surface on the Z2 side) of the third substrate layer 133. The microphone unit body 10 is mounted on the substrate 3 (see FIGS. 1 and 2) by soldering through these electrode pads. The third substrate layer 133 is rectangularly formed, and has two notches 133a in a plan view, as shown in FIG. 8.

As shown in FIG. 5, the first internal sound hole 171 guiding sound waves to the lower surface (surface on the Z2 side) of a diaphragm 141, described later, of the differential vibrating portion 14 is constituted by the sound hole 111 of the shield 11, the sound hole 121 of the cover substrate 12, the sound hole 131a of the base substrate 13, the hollow portion 132a, and the sound hole 131b. The second internal sound hole 172 guiding sound waves to the upper surface (surface on the Z1 side) of the diaphragm 141, described later, of the differential vibrating portion 14 is constituted by the sound hole 112 of the shield 11, the sound hole 122 of the cover substrate 12, and the recess portion 123. The first internal sound hole 171 is configured to guide sound waves from the upper side (Z1 side) of the cover substrate 12 toward the exposed lower surface of the diaphragm 141. The second internal sound hole 172 is configured to guide sound waves from the upper side (Z1 side) of the cover substrate 12 toward the upper surface of the diaphragm 141 through a back plate electrode 142, described later, of the differential vibrating portion 14. In other words, both an end portion (end portion on the Z1 side) of the first internal sound hole 171 closer to the first external sound hole 201 of the sound hole forming member 20 and an end portion (end portion on the Z1 side) of the second internal sound hole 172 closer to the second external sound hole 202 of the sound hole forming member 20 are arranged in the upper surface portion 11a of the shield 11 arranged parallel to the main surface 21 of the outer housing 2. The first internal sound hole 171 and the second internal sound hole 172 are configured to be connected to the first external sound hole 201 and the second external sound hole 202 of the sound hole forming member 20, respectively, through openings 401 and 402, described later, of the gasket 40. The gasket 40 is made of sponge-like Poron (registered trademark), and has a function of suppressing sound leakage from between the sound hole forming member 20 and the microphone unit body 10. The gasket 40 is an example of the “sound leakage prevention member” in the present invention.

The differential vibrating portion 14 is arranged on the upper surface of the first substrate layer 131 to cover the sound hole 131b of the first substrate layer 131, as shown in FIGS. 4 and 5. The differential vibrating portion 14 has the diaphragm 141 vibrating due to sound waves and the back plate electrode 142 arranged to be opposed to the upper surface (surface on the Z1 side) of the diaphragm 141, as shown in FIG. 5. The differential vibrating portion 14 is configured to detect capacitance change and convert sound waves to electric signals. The differential vibrating portion 14 converts sound waves to electric signals on the basis of vibration of the diaphragm 141. The differential vibrating portion 14 is configured to detect sound waves on the basis of differences between sound pressures arriving through the first external sound hole 201 of the sound hole forming member 20 and the first internal sound hole 171 and sound pressures arriving through the second external sound hole 202 of the sound hole forming member 20 and the second internal sound hole 172. The differential vibrating portion 14 is bonded to the upper surface of the base substrate 13 by an unshown bonding layer. The differential vibrating portion 14 is connected to a circuit portion 15 by bonding wires 15a (made of gold, for example), as shown in FIG. 5. The back plate electrode 142 is formed with a plurality of small diameter through-holes each having a diameter of several μm, and allows sound waves to pass therethrough to the diaphragm 141.

These through-holes each are formed with a diameter of several μm, whereby dust (dust of about several 10 μm, for example) larger than the diameters of the through-holes can be prevented from reaching the diaphragm 141. Thus, large dust (dust of about several 10 μm, for example) can be prevented from influencing vibration of the diaphragm 141 by landing on the diaphragm 141.

The two circuit portions 15 are provided on the upper surface of the first substrate layer 131, as shown in FIG. 4. The two circuit portions 15 are configured to process electric signals output from the differential vibrating portion 14 and the omnidirectional vibrating portion 18, respectively. The circuit portions 15 are bonded to the upper surface of the first substrate layer 131 by unshown bonding layers. The circuit portions 15 are connected to the bonding pads 131c by bonding wires (made of gold, for example).

The three chip capacitors 16 are provided on the upper surface of the first substrate layer 131, as shown in FIG. 4. The chip capacitors 16 are soldered to the pads 131d to be mounted on the first substrate layer 131.

The omnidirectional vibrating portion 18 is arranged on the upper surface of the first substrate layer 131, as shown in FIGS. 4 and 5. Similarly to the differential vibrating portion 14, the omnidirectional vibrating portion 18 has a diaphragm 181 vibrating due to sound waves and a back plate electrode 182 arranged to be opposed to the upper surface (surface on the Z1 side) of the diaphragm 181, as shown in FIG. 5. The omnidirectional vibrating portion 18 converts sound waves to electric signals on the basis of vibration of the diaphragm 181. The omnidirectional vibrating portion 18 is configured to detect sound waves arriving through the second external sound hole 202 of the sound hole forming member 20 and the second internal sound hole 172. The omnidirectional vibrating portion 18 is bonded to the upper surface of the base substrate 13 by an unshown bonding layer.

According to the first embodiment, the sound hole forming member 20 is provided with the first external sound hole 201 and the second external sound hole 202 both extending toward the common side surface 22 orthogonal to the main surface 21 of the outer housing 2 of the portable telephone 100, as shown in FIGS. 2 and 9 to 11. Specifically, the first external sound hole 201 and the second external sound hole 202 each are provided to extend from the top surface 203a of a recess portion 203 formed in the lower surface 20a of the sound hole forming member 20 toward a side surface 20b on the Y2 side, orthogonal to the top surface 203a. The side surface 20b of the sound hole forming member 20 is arranged to be opposed to the side surface 22 of the outer housing 2. The gasket 40 and the microphone unit body 10 are arranged in the recess portion 203 of the sound hole forming member 20.

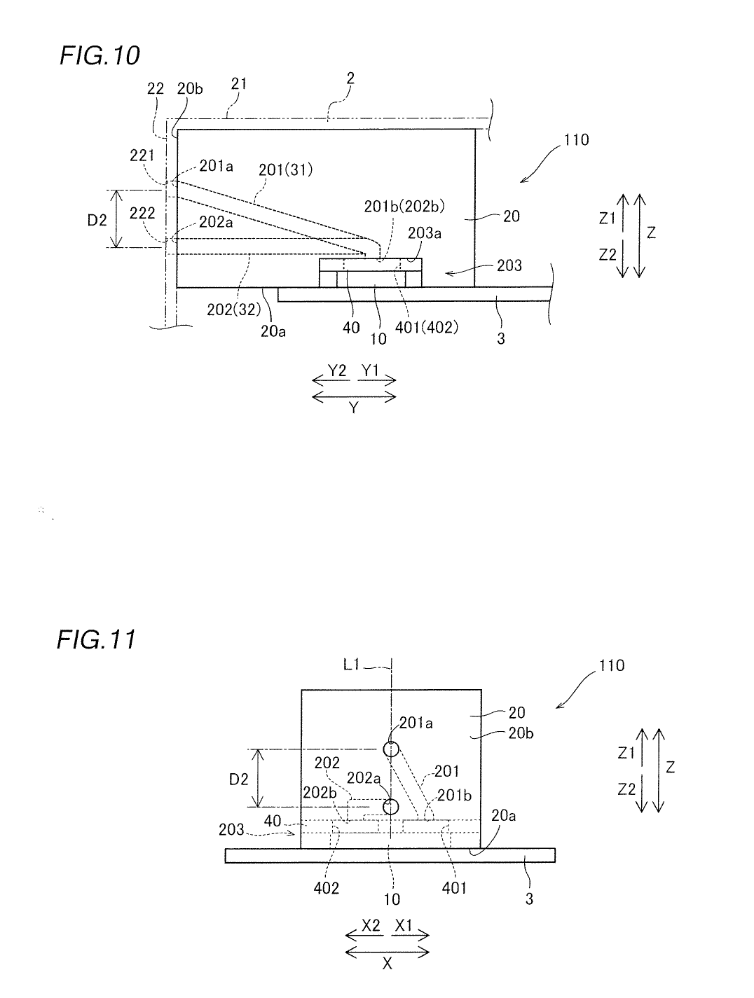

The first external sound hole 201 is formed to linearly extend vertically upward (along arrow Z1) from the top surface 203a of the recess portion 203 and thereafter linearly extend obliquely upward to the side surface 20b, as shown in FIG. 10. The second external sound hole 202 is formed to linearly extend vertically upward (along arrow Z1) from the top surface 203a of the recess portion 203 and thereafter linearly extend horizontally to the side surface 20b. In other words, the first external sound hole 201 and the second external sound hole 202 respectively are so formed that the vicinity of a second end portion 201b of the first external sound hole 201 and the vicinity of a second end portion 202b of the second external sound hole 202 are orthogonal to the upper surface portion 11a of the microphone unit body 10 provided with the end portion of the first internal sound hole 171 closer to the first external sound hole 201 and the end portion of the second internal sound hole 172 closer to the second external sound hole 202. Furthermore, the first external sound hole 201 and the second external sound hole 202 each are formed to extend toward the side surface 22 orthogonal to the main surface 21 of the outer housing 2 by bending. As shown in FIG. 9, the first external sound hole 201 (second external sound hole 202) are formed to extend to the side surface 20b while inclining along arrow X2 (arrow X1) in a plan view. The first external sound hole 201 and the second external sound hole 202 have lengths substantially equal to each other. Furthermore, the first external sound hole 201 and the second external sound hole 202 have circular cross-sectional shapes (1.5 mm in diameter, for example) substantially identical to each other in directions orthogonal to the traveling directions of sound waves. In other words, the first external sound hole 201 and the second external sound hole 202 have cross-sectional areas substantially equal to each other in the directions orthogonal to the traveling directions of sound waves.

As shown in FIG. 10, a first end portion 201a (end portion closer to the side surface 20b) of the first external sound hole 201 closer to the side surface 22 and a first end portion 202a (end portion closer to the side surface 20b) of the second external sound hole 202 closer to the side surface 22 are so arranged that the vertical distances thereof from the main surface 21 of the outer housing 2 are different from each other. More specifically, the first end portion 201a of the first external sound hole 201 and the first end portion 202a of the second external sound hole 202 are spaced from each other on the same axis line L1 orthogonal to the main surface 21 of the outer housing 2, as shown in FIG. 11.

As shown in FIGS. 10 and 11, the first end portion 201a of the first external sound hole 201 and the first end portion 202a of the second external sound hole 202 are provided at a distance D2 (3.5 mm, for example) smaller than a distance D1 (5 mm, for example) (see FIG. 9) between the second end portion 201b of the first external sound hole 201 and the second end portion 202b of the second external sound hole 202. The first end portion 202a of the second external sound hole 202 is arranged below (on the Z2 side) the first end portion 201a of the first external sound hole 201. In other words, the first end portion 202a of the second external sound hole 202 is so arranged that the vertical distance thereof from the main surface 21 of the outer housing 2 is larger than the vertical distance of the first end portion 201a of the first external sound hole 201 from the main surface 21 of the outer housing 2.

The second end portion 201b (end portion closer to the top surface 203a) of the first external sound hole 201 and the second end portion 202b (end portion closer to the top surface 203a) of the second external sound hole 202 are provided in positions of the sound hole forming member 20 corresponding to the first internal sound hole 171 and the second internal sound hole 172 of the microphone unit body 10, respectively. Thus, the first external sound hole 201 and the second external sound hole 202 are connected to the first internal sound hole 171 and the second internal sound hole 172 through the openings 401 and 402 of the gasket 40, respectively. As shown in FIG. 9, the second end portion 201b of the first external sound hole 201 (second end portion 202b of the second external sound hole 202) has an opening area smaller than that of the first internal sound hole 171 (second internal sound hole 172) in the form of a track. Furthermore, the second end portion 201b of the first external sound hole 201 (second end portion 202b of the second external sound hole 202) is arranged to overlap with the first internal sound hole 171 (second internal sound hole 172) in a plan view. The opening 401 (402) of the gasket 40 has a rectangular shape in a plan view, and is formed to entirely expose the first internal sound hole 171 (second internal sound hole 172). The second end portion 201b of the first external sound hole 201 and the second end portion 202b of the second external sound hole 202 are provided at the distance D1 (5 mm, for example) from each other.

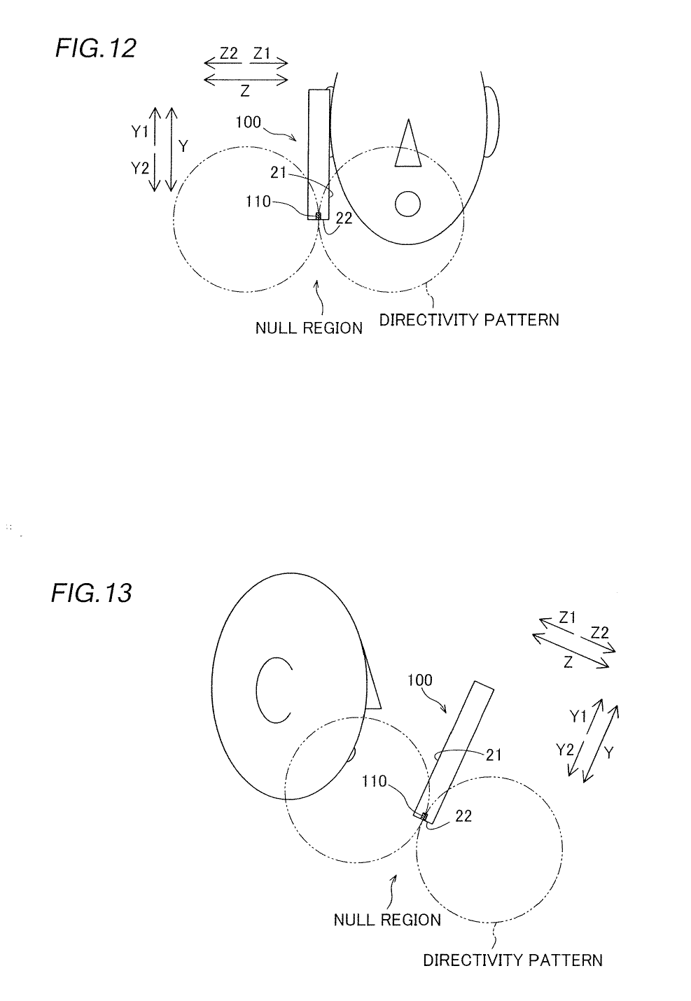

According to the first embodiment, as hereinabove described, the first sound hole 31 and the second sound hole 32 each guiding sound waves to the differential vibrating portion 14 are provided to extend toward the side surface 22 intersecting with the main surface 21 of the portable telephone 100, and the first end portion 201a of the first external sound hole 201 of the first sound hole 31 and the first end portion 202a of the second external sound hole 202 of the second sound hole 32 are so arranged that the vertical distances thereof from the main surface 21 of the portable telephone 100 are different from each other, whereby two voice detectable regions of a figure-eight directivity pattern can be arranged adjacent to each other in a direction intersecting with the main surface 21 of the portable telephone 100. Thus, a Null region can be spread on the side of the side surface 22 (Y2 side) intersecting with the main surface 21 of the portable telephone 100 while being inhibited from being spread on the side of the main surface 21 of the portable telephone 100. Consequently, voice output from a sound source located on the side of the main surface 21 of the portable telephone 100 can be accurately detected while noise on the side of the side surface 22 intersecting with the main surface 21 of the portable telephone 100 is removed. In other words, the Null region can be located on the side of the side surface 22 intersecting with the main surface 21, and hence one of the two voice detectable regions of a figure-eight directivity pattern can substantially cover the side of the main surface 21. Thus, the aforementioned single voice detectable region is arranged on a straight line from the user's mouth (sound source) toward the first end portion 201a of the first external sound hole 201 and the first end portion 202a of the second external sound hole 202, as shown in FIGS. 12 and 13, and hence the voice of the user can be captured with high sensitivity.

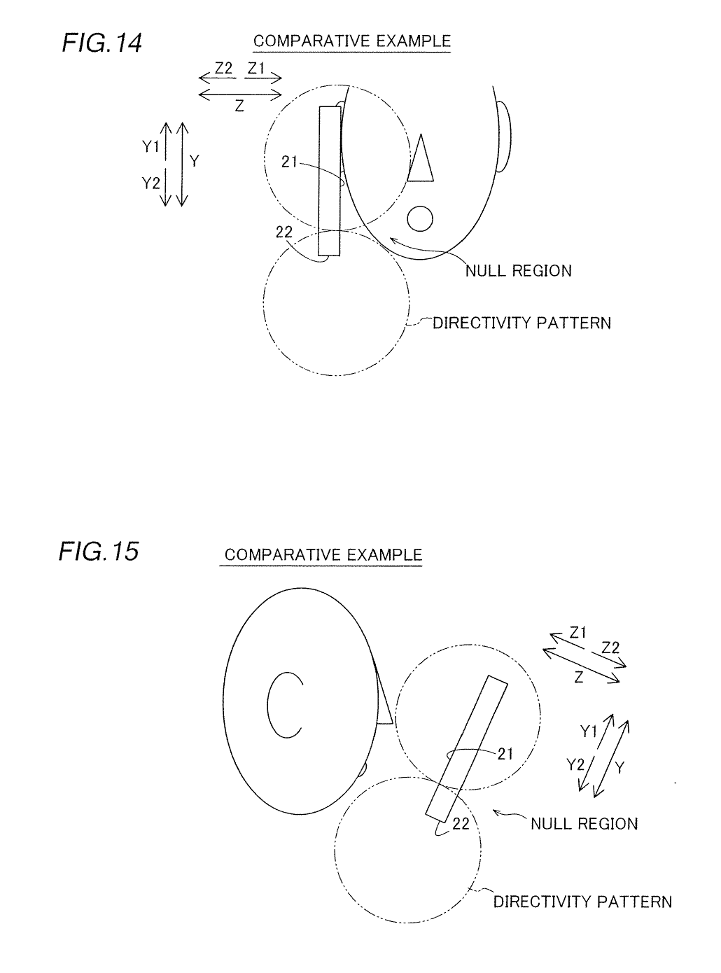

The user's mouth (sound source) is located on the side of the main surface 21 of the portable telephone 100 in both of a case where the user holds the portable telephone 100 according to the first embodiment up to the side of his/her face while aligning his/her ear with the portable telephone 100, as shown in FIG. 12 and a case where the user holds the portable telephone 100 according to the first embodiment up to the front side of his/her face while seeing the display portion 1 (see FIG. 1) of the portable telephone 100, as shown in FIG. 13. Therefore, the portable telephone 100 according to the first embodiment capable of accurately detecting the voice output from the sound source located on the side of the main surface 21 is effective. In a case where the first sound hole and the second sound hole are provided to extend toward the main surface 21, on the other hand, the Null region faces the side of the main surface 21, as shown in FIGS. 14 and 15, so that the voice output from the sound source located on the side of the main surface 21 is difficult to detect.

According to the first embodiment, the first sound hole 31 and the second sound hole 32 are provided to extend toward the common side surface 22 intersecting with the main surface 21 of the portable telephone 100. Thus, the first end portion 201a of the first external sound hole 201 of the first sound hole 31 and the first end portion 202a of the second external sound hole 202 of the second sound hole 32 can be easily put close to each other, and hence the first sound hole 31 and the second sound hole 32 can be arranged in a smaller arrangement space.

According to the first embodiment, the first end portion 201a of the first external sound hole 201 and the first end portion 202a of the second external sound hole 202 are separately arranged at the distance D2, which is smaller than the distance D1 between the second end portion 201b of the first external sound hole 201 and the second end portion 202b of the second external sound hole 202, from each other. Thus, the distance D2 between the first end portion 201a of the first external sound hole 201 and the first end portion 202a of the second external sound hole 202 can be rendered smaller, and hence increase in the thickness of the portable telephone 100 in the direction (direction Z) intersecting with the main surface 21, resulting from the arrangement of the first external sound hole 201 and the second external sound hole 202 can be suppressed. Consequently, the thickness of the portable telephone 100 can be reduced.

According to the first embodiment, the first end portion 201a of the first external sound hole 201 and the first end portion 202a of the second external sound hole 202 are spaced from each other on the same axis line L1 substantially orthogonal to the main surface 21 of the portable telephone 100. Thus, the two voice detectable regions of a figure-eight directivity pattern can be arranged adjacent to each other in a direction substantially orthogonal to the main surface 21 of the portable telephone 100, and hence the Null region can be further inhibited from being spread on the side of the main surface 21 of the portable telephone 100. Consequently, the voice output from the sound source located on the side of the main surface 21 of the portable telephone 100 can be more accurately detected.

According to the first embodiment, the omnidirectional vibrating portion 18 that detects sound waves arriving through the second external sound hole 202 is provided, and the first end portion 202a of the second external sound hole 202 is so arranged that the vertical distance thereof from the main surface 21 of the portable telephone 100 is larger than the vertical distance of the first end portion 201a of the first external sound hole 201 from the main surface 21 of the portable telephone 100. Thus, the second external sound hole 202 guiding sound waves to the omnidirectional vibrating portion 18 having sensitivity higher than that of the differential vibrating portion 14 is further distanced from the main surface 21 of the portable telephone 100 than the first external sound hole 201, and hence a difference between the sensitivity of the differential vibrating portion 14 and the sensitivity of the omnidirectional vibrating portion 18 with respect to the voice output from the sound source located on the side of the main surface 21 of the portable telephone 100 can be reduced. Consequently, the voice can be detected by the differential vibrating portion 14 and the omnidirectional vibrating portion 18 in a balanced manner.

According to the first embodiment, the microphone unit body 10 provided with the differential vibrating portion 14 and the first and second internal sound holes 171 and 172 is provided, and the first external sound hole 201 and the second external sound hole 202 are provided to extend from the first internal sound hole 171 and the second internal sound hole 172, respectively, toward the side surface 22 intersecting with the main surface 21 of the portable telephone 100. Thus, sound waves guided to the differential vibrating portion 14 provided in the microphone unit body 10 through the first internal sound hole 171 and the second internal sound hole 172 can be easily taken from the side surface 22 intersecting with the main surface 21 of the portable telephone 100 through the first external sound hole 201 and the second external sound hole 202, respectively.

According to the first embodiment, both the end portion of the first internal sound hole 171 closer to the first external sound hole 201 and the end portion of the second internal sound hole 172 closer to the second external sound hole 202 are provided in the upper surface portion 11a of the shield 11, which is arranged substantially parallel to the main surface 21 of the portable telephone 100, of the microphone unit body 10, and the first external sound hole 201 and the second external sound hole 202 are provided to extend from the first internal sound hole 171 and the second internal sound hole 172, respectively, toward the side surface 22 orthogonal to the main surface 21 of the portable telephone 100 by bending. Thus, the first external sound hole 201 and the second external sound hole 202 are provided to extend in a direction orthogonal to the upper surface portion 11a of the shield 11 of the microphone unit body 10 provided with the respective end portions of the first internal sound hole 171 and the second internal sound hole 172, and hence sound waves can be easily taken from the direction orthogonal to the upper surface portion 11a of the shield 11 of the microphone unit body 10 provided with the respective end portions of the first internal sound hole 171 and the second internal sound hole 172.

According to the first embodiment, the first external sound hole 201 and the second external sound hole 202 are provided to extend from one of two surfaces, substantially orthogonal to each other, of the sound hole forming member 20 toward the other, thereby extending toward the side surface 22 intersecting with the main surface 21 of the portable telephone 100. Thus, the traveling directions of sound waves are bent in an orthogonal direction by the first external sound hole 201 and the second external sound hole 202 formed in the sound hole forming member 20, and hence sound waves can be more easily taken from the direction orthogonal to the upper surface portion 11a of the shield 11 of the microphone unit body 10 provided with the respective end portions of the first internal sound hole 171 and the second internal sound hole 172.

According to the first embodiment, the first external sound hole 201 and the second external sound hole 202 are configured to have the cross-sectional shapes substantially identical to each other in the directions orthogonal to the traveling directions of sound waves. Thus, a difference between the ease (difficulty) of passage of sound waves through the first external sound hole 201 and the ease (difficulty) of passage of sound waves through the second external sound hole 202 can be reduced, and hence sound waves arriving through the respective ones of the first external sound hole 201 and the second external sound hole 202 can be detected by the differential vibrating portion 14 in a balanced manner. Consequently, the accuracy of detecting voice can be improved.

According to the first embodiment, the first external sound hole 201 and the second external sound hole 202 are configured to have the lengths substantially equal to each other. Thus, a difference between the attenuation of sound waves passing through the first external sound hole 201 and the attenuation of sound waves passing through the second external sound hole 202 can be reduced, and hence the sound waves arriving through the respective ones of the first external sound hole 201 and the second external sound hole 202 can be detected by the differential vibrating portion 14 in a balanced manner. Consequently, the accuracy of detecting voice can be improved.

According to the first embodiment, the main surface 21 of the portable telephone 100 is a surface arranged parallel to the main surface of the substrate 3 mounted with the differential vibrating portion 14. Thus, the sound waves taken from the side surface 22 intersecting with the main surface of the substrate 3 can be guided to the differential vibrating portion 14 by the first external sound hole 201 and the second external sound hole 202.

According to the first embodiment, the first opening 221 and the second opening 222 corresponding to the first end portion 201a of the first external sound hole 201 and the first end portion 202a of the second external sound hole 202, respectively are formed in a surface of the outer housing 2 intersecting with the main surface 21. Thus, sound waves can be easily taken from the outside of the outer housing 2 into the first external sound hole 201 and the second external sound hole 202 through the first and second openings 221 and 222 formed in the outer housing 2, respectively.

According to the first embodiment, the main surface 21 is provided to be orthogonal to the thickness direction (direction Z) of the flat outer housing 2. Thus, in the portable telephone 100 having the flat outer housing 2, the Null region can be inhibited from being spread on the side of the main surface 21 orthogonal to the thickness direction of the outer housing 2, and hence the voice output from the sound source located on the side of the main surface 21 of the outer housing 2 can be accurately detected.

According to the first embodiment, the first external sound hole 201 and the second external sound hole 202 respectively are so formed that the vicinity of the second end portion 201b of the first external sound hole 201 and the vicinity of the second end portion 202b of the second external sound hole 202 are orthogonal to the upper surface portion 11a of the shield 11 of the microphone unit body 10 arranged substantially parallel to the main surface 21 of the portable telephone 100, which is provided with the end portion of the first internal sound hole 171 closer to the first external sound hole 201 and the end portion of the second internal sound hole 172 closer to the second external sound hole 202. Thus, through the first external sound hole 201 and the second external sound hole 202, the traveling directions of sound waves face the direction orthogonal to the upper surface portion 11a of the microphone unit body 10 provided with the end portion of the first internal sound hole 171 closer to the first external sound hole 201 and the end portion of the second internal sound hole 172 closer to the second external sound hole 202 in the vicinity of the first internal sound hole 171 and the second internal sound hole 172, respectively, and hence sound waves can be easily taken into the microphone unit body 10.

According to the first embodiment, the end portion of the first internal sound hole 171 closer to the first external sound hole 201 and the end portion of the second internal sound hole 172 closer to the second external sound hole 202 are formed to have the opening areas larger than those of the second end portion 201b of the first external sound hole 201 closer to the first internal sound hole 171 and the second end portion 202b of the second external sound hole 202 closer to the second internal sound hole 172, respectively. Thus, sound waves guided through the first external sound hole 201 and the second external sound hole 202 can be reliably taken from the first internal sound hole 171 and the second internal sound hole 172 into the microphone unit body 10, respectively.

According to the first embodiment, the first internal sound hole 171 and the second internal sound hole 172 are connected to the first external sound hole 201 and the second external sound hole 202 through the gasket 40, respectively. Thus, sound leakage from a connection portion between the first internal sound hole 171 and the first external sound hole 201 and a connection portion between the second internal sound hole 172 and the second external sound hole 202 can be prevented by the gasket 40, and hence sound waves can be efficiently taken into the microphone unit body 10.

### Second Embodiment

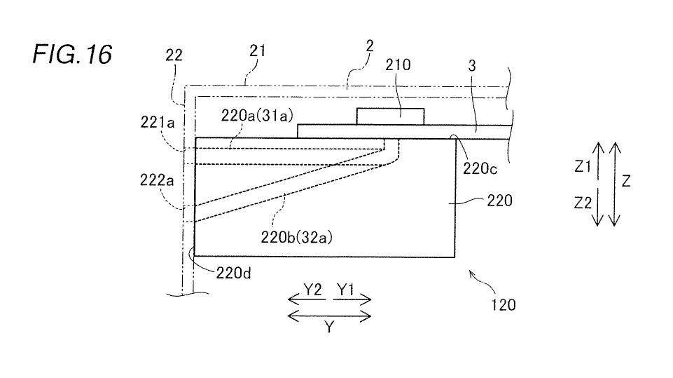

A MEMS microphone 120 of a portable telephone 100 according to a second embodiment of the present invention is hereinafter described with reference to FIGS. 16 to 21. In this second embodiment, a first internal sound hole 271 and a second internal sound hole 272 are provided to guide sound waves from the lower side (Z2 side) of a base substrate 213 to a differential vibrating portion 14 and an omnidirectional vibrating portion 18, dissimilarly to the aforementioned first embodiment. The MEMS microphone 120 is an example of the “microphone unit” in the present invention.

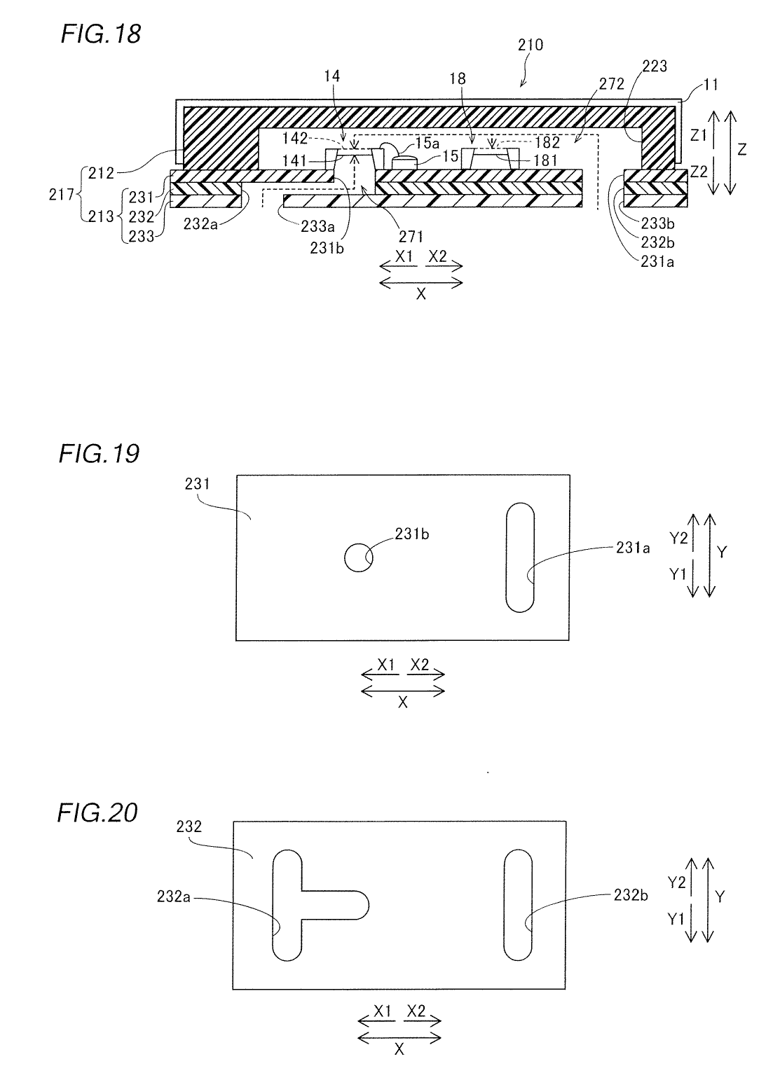

According to the second embodiment, the portable telephone 100 includes a microphone unit body 210 and a sound hole forming member 220, as shown in FIG. 16. The MEMS microphone 120 is mounted on a substrate 3. The microphone unit body 210 is provided with two sound holes (the first internal sound hole 271 and the second internal sound hole 272), as shown in FIG. 18, and the sound hole forming member 220 is provided with a first external sound hole 220a and a second external sound hole 220b corresponding to the respective ones of these sound holes. As shown in FIG. 16, the first internal sound hole 271 (see FIG. 18) and the first external sound hole 220a constitute a first sound hole 31a extending toward a side surface 22 of an outer housing 2. The second internal sound hole 272 (see FIG. 18) and the second external sound hole 220b constitute a second sound hole 32a extending toward the side surface 22 of the outer housing 2.

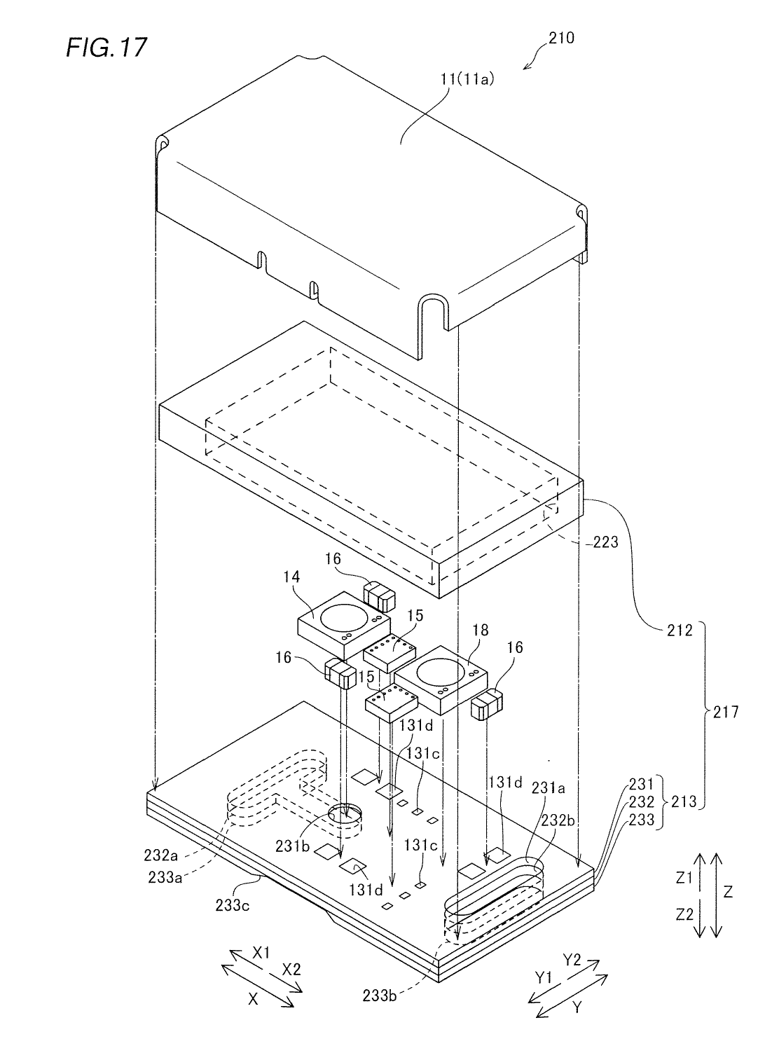

In the microphone unit body 210, a cover substrate 212 and the base substrate 213 constitute a microphone outer housing 217, as shown in FIGS. 17 and 18. The cover substrate 212 is formed with a recess portion 223 housing the differential vibrating portion 14 and the omnidirectional vibrating portion 18.

The base substrate 213 is made of glass epoxy resin such as FR-4, similarly to the cover substrate 212. The base substrate 213 has a three-layer structure of first, second, and third substrate layers 231, 232, and 233. Specifically, the first substrate layer 231, the second substrate layer 232, and the third substrate layer 233 are bonded to each other by unshown bonding sheets.

The first substrate layer 231 is formed with a sound hole 231a in the form of a track and a circular sound hole 231b spaced in a direction X from the sound hole 231a, as shown in FIG. 19. The sound holes 231a and 231b are formed in shapes identical to those of the sound holes 131a and 131b according to the aforementioned first embodiment, respectively. The circular sound hole 231b is provided in a position of the first substrate layer 231 corresponding to the differential vibrating portion 14.

The second substrate layer 232 is formed with a T-shaped hollow portion 232a in a plan view, similarly to the second substrate layer 132 according to the aforementioned first embodiment, as shown in FIG. 20. The hollow portion 232a is configured to cause the sound hole 231b of the first substrate layer 231 and a sound hole 233a of the third substrate layer 233 to communicate with each other. The second substrate layer 232 is formed with a sound hole 232b in a shape identical to that of the sound hole 231a to correspond to the sound hole 231a of the first substrate layer 231.

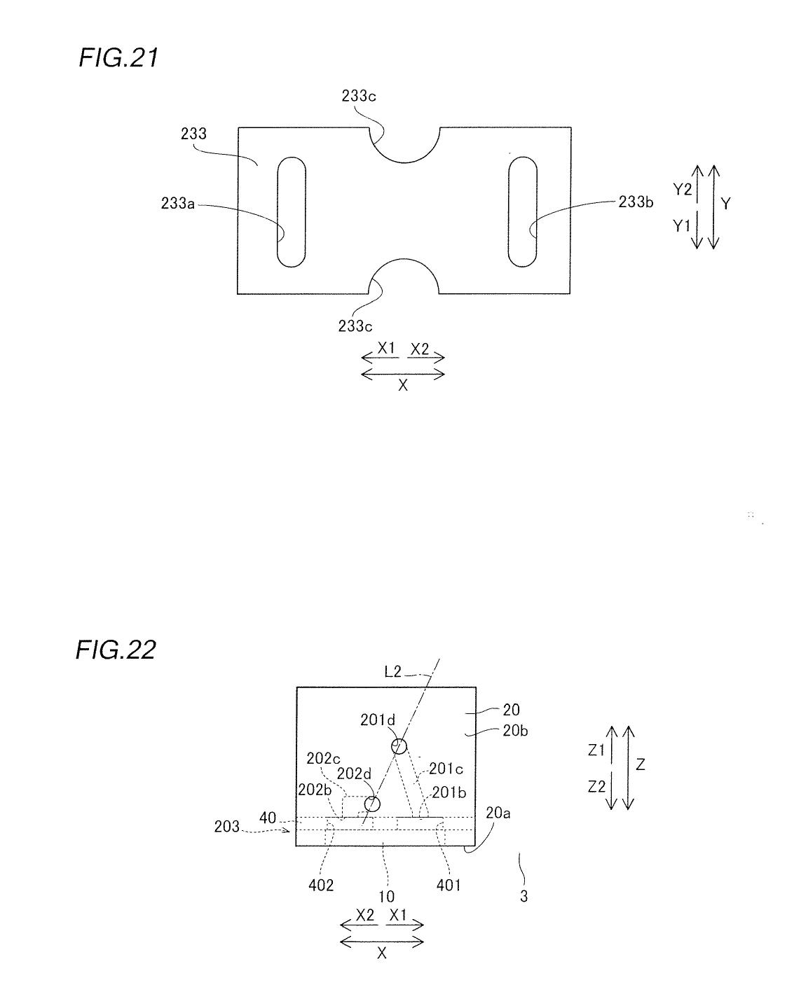

The third substrate layer 233 is formed with the sound hole 233a in the form of a track, as shown in FIG. 21. According to the second embodiment, the sound hole 233a of the third substrate layer 233, the hollow portion 232a of the second substrate layer 232, and the sound hole 231b of the first substrate layer 231 constitute the first internal sound hole 271 guiding sound waves to the lower surface (surface on the Z2 side) of a diaphragm 141 of the differential vibrating portion 14.

The third substrate layer 233 is formed with a sound hole 233b in a shape identical to that of the sound hole 232b to correspond to the sound hole 232b of the second substrate layer 232. According to the second embodiment, the sound hole 233b of the third substrate layer 233, the sound hole 232b of the second substrate layer 232, the sound hole 231a of the first substrate layer 231, and the recess portion 223 of the cover substrate 212 constitute the second internal sound hole 272 guiding sound waves to the upper surface (surface on a Z1 side) of the diaphragm 141 of the differential vibrating portion 14 through a back plate electrode 142. The first internal sound hole 271 and the second internal sound hole 272 are configured to be connected to the first external sound hole 220a and the second external sound hole 220b of the sound hole forming member 220 through unshown through-holes of the substrate 3, respectively. The third substrate layer 233 has two notches 233c.

The sound hole forming member 220 is provided below the substrate 3, as shown in FIG. 16. The sound hole forming member 220 is provided with the first external sound hole 220a and the second external sound hole 220b both extending toward the common side surface 22 orthogonal to a main surface 21 of the outer housing 2 of the portable telephone 100. Specifically, the first external sound hole 220a and the second external sound hole 220b each are provided to extend from the upper surface 220c of the sound hole forming member 220 toward a side surface 220d on a Y2 side, orthogonal to the upper surface 220c. The side surface 220d of the sound hole forming member 220 is arranged to be opposed to the side surface 22 of the outer housing 2. In other words, the first external sound hole 220a and the second external sound hole 220b each are formed to extend toward the side surface 22 orthogonal to the main surface 21 of the outer housing 2. A first opening 221a and a second opening 222a corresponding to the first external sound hole 220a and the second external sound hole 220b, respectively, are formed in the side surface 22 of the outer housing 2.

The remaining structure of the portable telephone 100 according to the second embodiment is similar to that of the portable telephone 100 according to the aforementioned first embodiment.

Also according to the structure of the portable telephone 100 according to the second embodiment in which sound waves are taken from the lower side (Z2 side) of the base substrate 213, two voice detectable regions of a figure-eight directivity pattern can be arranged adjacent to each other in a direction intersecting with the main surface 21 of the portable telephone 100, similarly to the aforementioned first embodiment, and hence a Null region can be spread on the side of the side surface 22 (Y2 side) intersecting with the main surface 21 of the portable telephone 100 while being inhibited from being spread on the side of the main surface 21 of the portable telephone 100. Thus, voice output from a sound source located on the side of the main surface 21 of the portable telephone 100 can be accurately detected while noise on the side of the side surface 22 intersecting with the main surface 21 of the portable telephone 100 is removed.

The remaining effects of the second embodiment are similar to those of the aforementioned first embodiment.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are included.

For example, while the present invention is applied to the portable telephone serving as the example of the electronic apparatus according to the present invention in each of the aforementioned first and second embodiments, the present invention is not restricted to this. The present invention may alternatively be applied to an electronic apparatus other than the portable telephone. For example, the present invention may be applied to an electronic apparatus mounted with a microphone unit, such as a digital camera, a video camera, a voice recorder, a personal digital assistant, a PC (personal computer), or the like.

While the first end portion of the first external sound hole constituting the first sound hole and the first end portion of the second external sound hole constituting the second sound hole are arranged on the same axis line L1 orthogonal to the main surface in the aforementioned first embodiment, the present invention is not restricted to this. According to the present invention, a first end portion 201d of a first external sound hole 201c and a first end portion 202d of a second external sound hole 202c may alternatively be spaced from each other on an axis line L2 inclining with respect to a main surface, as shown in FIG. 22. Thus, the thickness of an outer housing (electronic apparatus housing) can be reduced. Furthermore, in view of design, positions where the first opening and the second opening are provided can be changed, for example, by providing the first external sound hole and the second external sound hole to extend to an edge of the side surface of the outer housing.

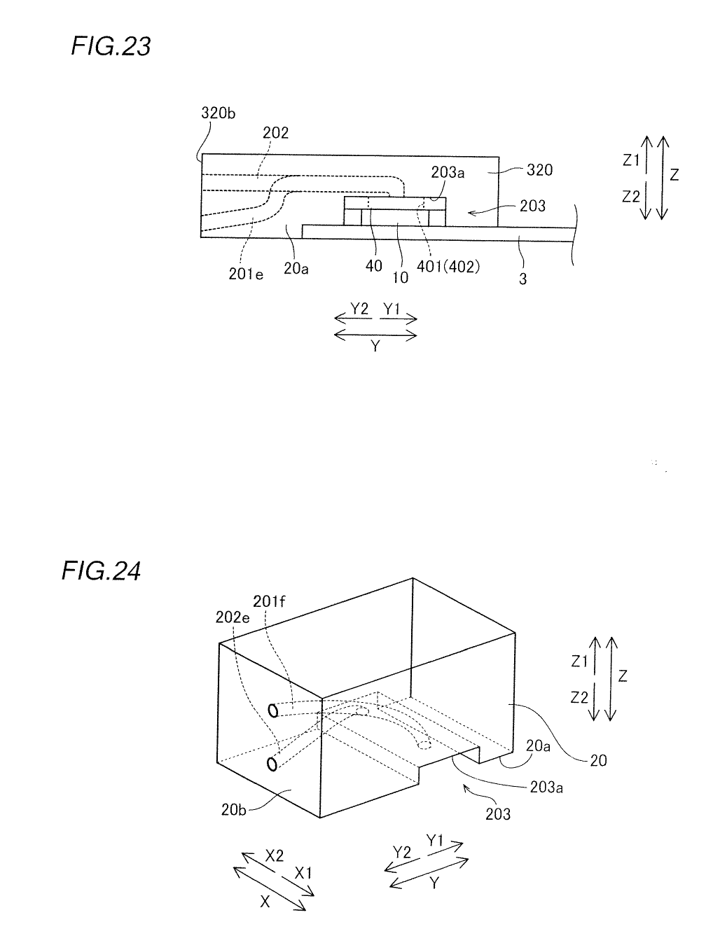

While the first external sound hole is formed to linearly extend obliquely upward to the side surface of the sound hole forming member in the aforementioned first embodiment, the present invention is not restricted to this. According to the present invention, a first external sound hole 201e may alternatively be formed to extend obliquely downward to a side surface 320b of a sound hole forming member 320, as shown in FIG. 23. In this case, a second external sound hole may also alternatively be formed to extend obliquely downward. Thus, increase in the arrangement space of the first external sound hole and the second external sound hole in a height direction (direction Z) can be suppressed, and hence the height of the sound hole forming member can be reduced. Consequently, an electronic apparatus mounted with a microphone unit can be downsized.

While the first external sound hole and the second external sound hole each are formed to extend toward the side surface orthogonal to the main surface by bending in the aforementioned first embodiment, the present invention is not restricted to this. According to the present invention, a first external sound hole 201f and a second external sound hole 202e each may alternatively be formed to extend toward a side surface orthogonal to a main surface by curving, as shown in FIG. 24. Alternatively, the first external sound hole and the second external sound hole may be formed to extend toward the side surface orthogonal to the main surface by a combination of curving and bending.

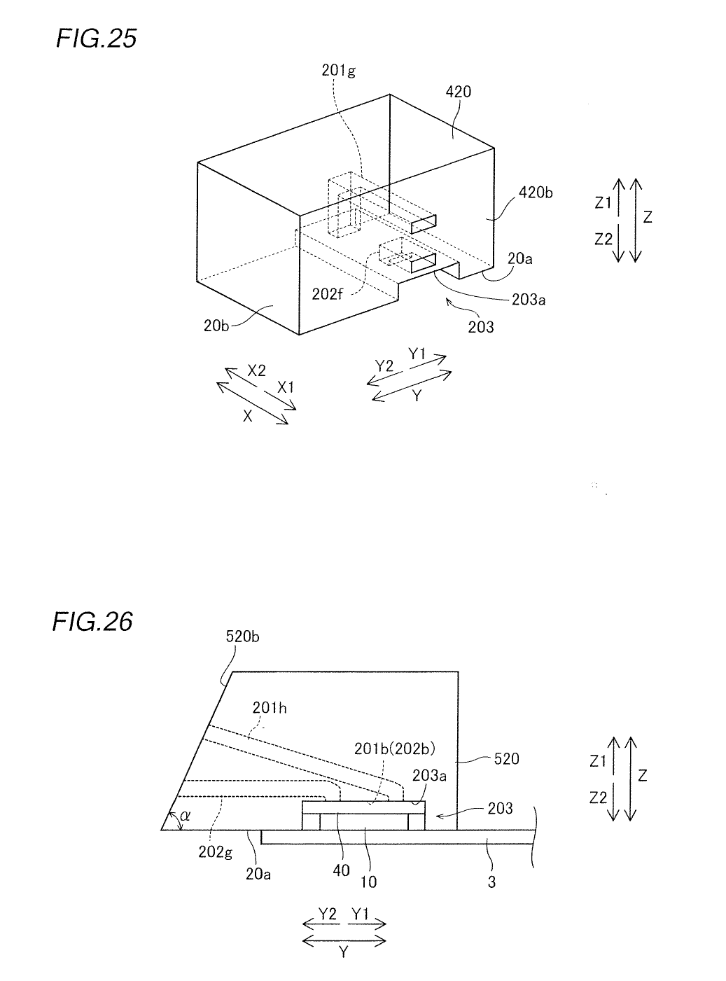

While the first external sound hole and the second external sound hole each are configured to have the circular cross-sectional shape in the direction orthogonal to the traveling direction of sound waves in the aforementioned first embodiment, the present invention is not restricted to this. According to the present invention, a first external sound hole 201g and a second external sound hole 202f each may alternatively be provided in a sound hole forming member 420 to have a rectangular cross-sectional shape in a direction orthogonal to the traveling direction of sound waves, as shown in FIG. 25, or the first external sound hole and the second external sound hole each may alternatively be configured to have a cross-sectional shape other than the circular cross-sectional shape and the rectangular cross-sectional shape. Furthermore, the first external sound hole and the second external sound hole may alternatively be configured to have cross-sectional shapes different from each other.

While the first external sound hole and the second external sound hole each are provided to extend toward the side surface (side surface orthogonal to the main surface) of the MEMS microphone 110 in a direction (direction Y) orthogonal to a direction (direction X) in which the two sound holes 171 and 172 are adjacent to each other in the aforementioned first embodiment, the present invention is not restricted to this. According to the present invention, the first external sound hole 201g and the second external sound hole 202f each may alternatively be provided to extend toward the side surface 420b of a microphone in a direction (direction X) in which two sound holes (a first internal sound hole and a second internal sound hole) are adjacent to each other, as shown in FIG. 25.

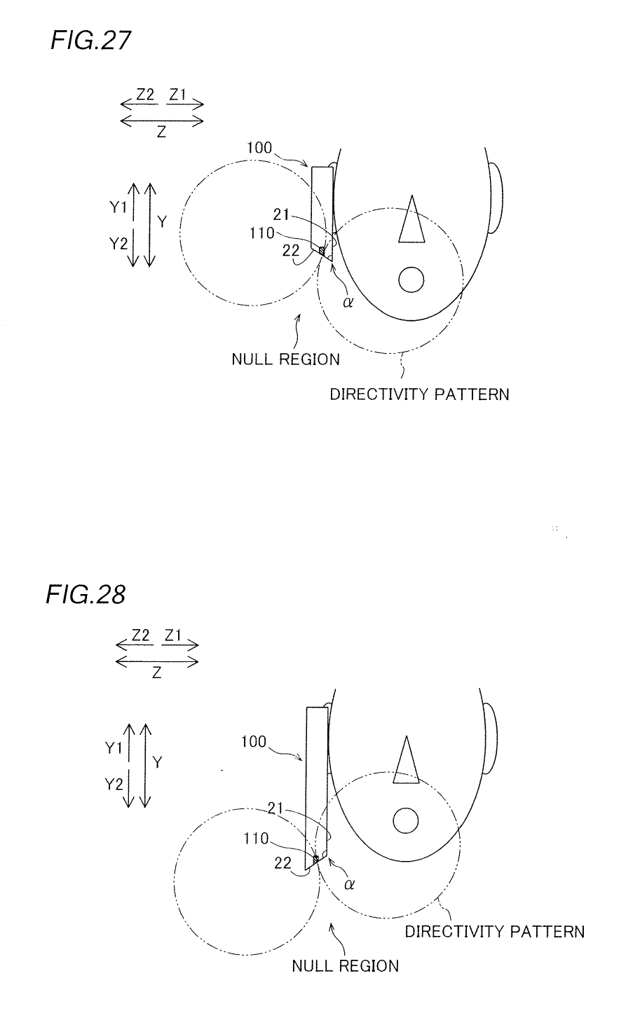

While the first external sound hole and the second external sound hole each are provided to extend from one of the two surfaces, orthogonal to each other, of the sound hole forming member toward the other in the aforementioned first embodiment, the present invention is not restricted to this. According to the present invention, a first external sound hole 201h and a second external sound hole 202g each may alternatively be provided to extend from one of two surfaces (a top surface 203a and a side surface 520b), inclined with respect to each other, of a sound hole forming member 520 toward the other, as shown in FIG. 26. Thus, the lengths of the first external sound hole and the second external sound hole can be easily adjusted simply by changing the inclination angle α between the two surfaces. The inclination angle α between the two surfaces is arbitrarily changeable, and the directivity can be rendered appropriate to the shape of an outer housing. For example, the directivity direction can be changed simply by changing the inclination angle α in a case where the length (longitudinal length) of the outer housing is short and in a case where the length (longitudinal length) of the outer housing is long, as shown in FIGS. 27 and 28.

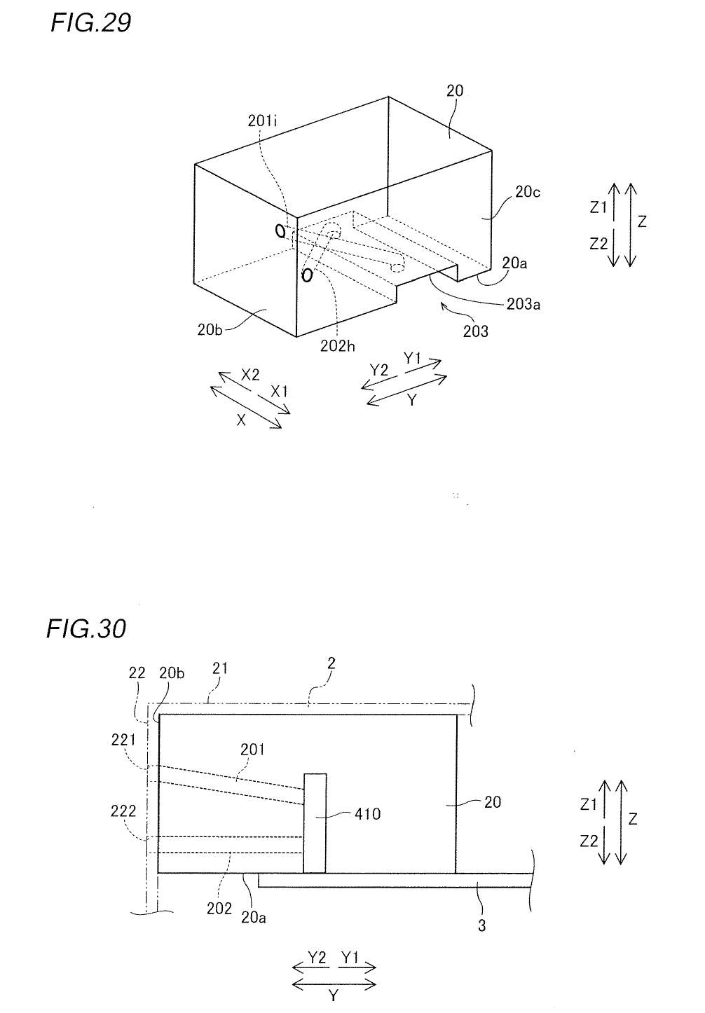

While the first external sound hole and the second external sound hole are provided to extend toward the common side surface orthogonal to the main surface in the aforementioned first embodiment, the present invention is not restricted to this. According to the present invention, a first external sound hole 201i and a second external sound hole 202h may alternatively be provided to extend toward different side surfaces (side surfaces 20b and 20c) orthogonal to a main surface, respectively, as shown in FIG. 29.

While the end portion of the first internal sound hole 171 (first internal sound hole) and the end portion of the second internal sound hole 172 (second internal sound hole) are arranged in the upper surface portion 11a of the shield 11 arranged parallel to the main surface 21 of the outer housing 2 in the aforementioned first embodiment, the present invention is not restricted to this. According to the present invention, an end portion of a first internal sound hole and an end portion of a second internal sound hole may alternatively be arranged in a surface orthogonal to a main surface 21 of an outer housing 2 of a microphone 410, as shown in FIG. 30.

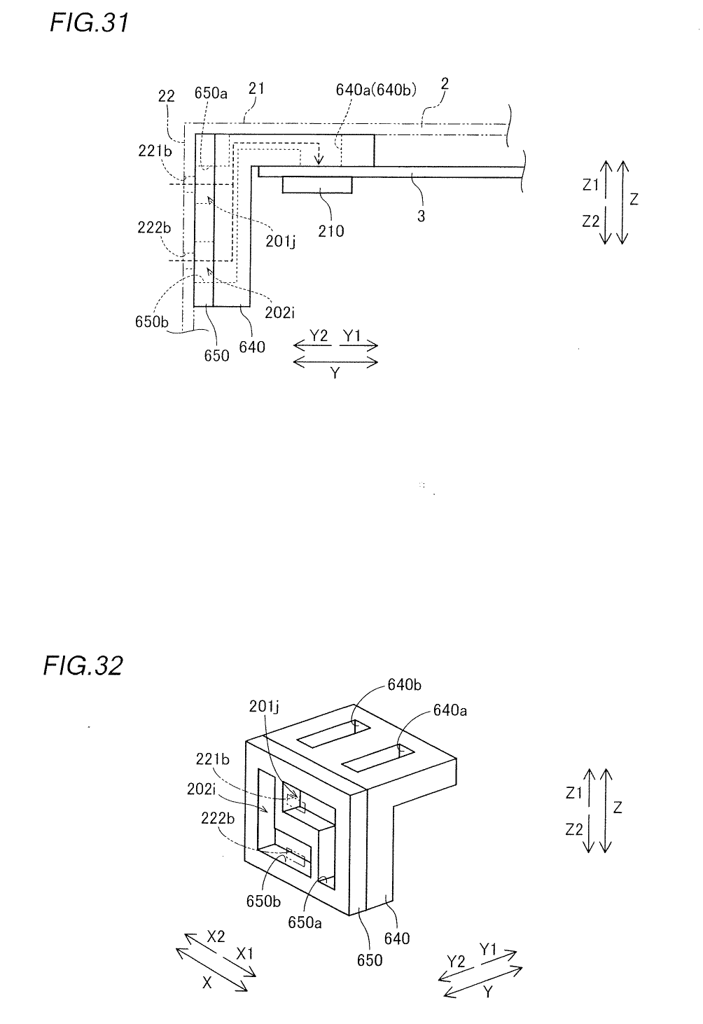

While the microphone is arranged on the upper surface of the substrate and sound waves are guided through the unshown through-holes of the substrate in the aforementioned second embodiment, the present invention is not restricted to this. According to the present invention, a microphone unit body 210 may alternatively be arranged on the lower surface (surface on a Z2 side) of a substrate 3 and sound waves may alternatively be guided to the microphone unit body 210 through unshown through-holes of the substrate 3, as shown in FIG. 31. In this case, a first external sound hole 201j and a second external sound hole 202i may alternatively be provided in an L-shaped resin member 640 and a waterproof film unit 650 arranged between the resin member 640 and an outer housing 2, as shown in FIGS. 31 and 32.

Specifically, two openings 640a and 640b connected to a first internal sound hole 271 and a second internal sound hole 272 (see FIG. 18) of the microphone unit body 210 through through-holes of the substrate 3, respectively, are formed in the resin member 640, as shown in FIG. 32. Furthermore, openings 650a and 650b connected to the two openings 640a and 640b of the resin member 640, respectively, are formed in the waterproof film unit 650.

Waterproof films are bonded to the openings 650a and 650b. In addition, a first opening 221b and a second opening 222b are provided in positions of a side surface 22 of the outer housing 2 corresponding to the openings 650a and 650b, respectively. In other words, the opening 640a of the resin member 640 and the opening 650a of the waterproof film unit 650 constitute the first external sound hole 201j. The opening 640b of the resin member 640 and the opening 650b of the waterproof film unit 650 constitute the second external sound hole 202i. Due to this structure, sound waves taken from the first opening 221b and the second opening 222b arranged adjacent to each other in a direction Z can be guided to end portions of the first internal sound hole 271 and the second internal sound hole 272 (see FIG. 18) arranged adjacent to each other in a direction X, closer to the external sound holes.

While both the differential vibrating portion and the omnidirectional vibrating portion are provided in each of the aforementioned first and second embodiments, the present invention is not restricted to this. According to the present invention, no omnidirectional vibrating portion may alternatively be provided, so far as the differential vibrating portion is provided. In a case where the omnidirectional vibrating portion is provided, the omnidirectional vibrating portion can be employed to use a portable telephone in a hands free manner.

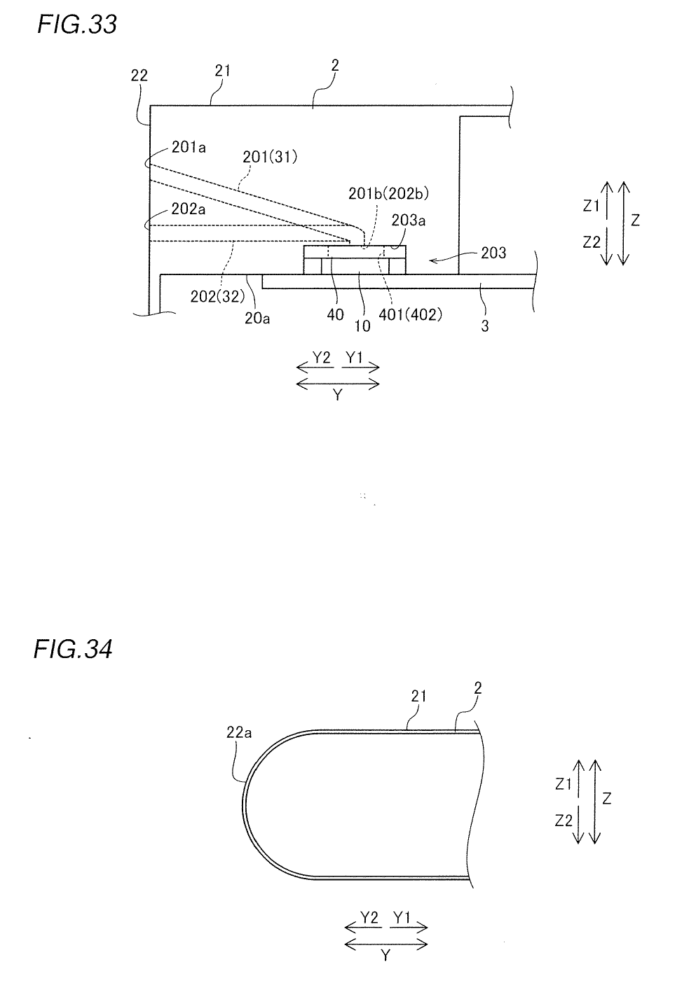

While the microphone and the sound hole forming member are formed separately from each other in each of the aforementioned first and second embodiments, the present invention is not restricted to this. According to the present invention, a microphone and a sound hole forming member may alternatively be integrally formed, as shown in FIG. 33. Alternatively, a sound hole forming member may be integrally formed on an outer housing of an electronic apparatus.

While the first external sound hole and the second external sound hole are formed to have the lengths substantially equal to each other in the aforementioned first embodiment, the present invention is not restricted to this. According to the present invention, the first external sound hole and the second external sound hole may alternatively be formed to have lengths different from each other. The length of the shorter one of the first external sound hole and the second external sound hole is preferably at least one half of the length of the longer one.

While the first external sound hole and the second external sound hole are provided to pass through the inside of the sound hole forming member in each of the aforementioned first and second embodiments, the present invention is not restricted to this. According to the present invention, the first external sound hole and the second external sound hole each may alternatively be formed of a tubular pipe.

While the outer housing is in the rectangular parallelepiped shape in the aforementioned first embodiment, the present invention is not restricted to this. According to the present invention, the outer housing may alternatively be in a shape other than the rectangular parallelepiped shape, such as a streamline shape. In this case, a first sound hole and a second sound hole may be provided toward a side surface 22a (surface intersecting with a main surface) continuously formed in a curved manner from the main surface 21, as shown in FIG. 34.

What is claimed is:

1. A microphone unit comprising a differential vibrating portion detecting a sound wave on the basis of a difference between a sound pressure arriving through a first sound hole and a sound pressure arriving through a second sound hole, wherein
the first sound hole and the second sound hole are provided to extend toward a surface of an electronic apparatus internally mounted with the differential vibrating portion, intersecting with a main surface of the electronic apparatus, and
an end portion of the first sound hole closer to the surface intersecting with the main surface of the electronic apparatus and an end portion of the second sound hole closer to the surface intersecting with the main surface of the electronic apparatus are so arranged that vertical distances of the end portions from the main surface of the electronic apparatus are different from each other.

2. The microphone unit according to claim 1, wherein
the first sound hole and the second sound hole are provided to extend toward the common surface intersecting with the main surface of the electronic apparatus.

3. The microphone unit according to claim 1, wherein
the end portion of the first sound hole and the end portion of the second sound hole are spaced from each other on the same axis line substantially orthogonal to the main surface of the electronic apparatus.

4. The microphone unit according to claim 1, further comprising an omnidirectional vibrating portion detecting a sound wave arriving through the second sound hole, wherein
the end portion of the second sound hole is so arranged that a vertical distance of the end portion of the second sound hole from the main surface of the electronic apparatus is larger than a vertical distance of the end portion of the first sound hole from the main surface of the electronic apparatus.

5. The microphone unit according to claim 1, wherein
the first sound hole includes a first internal sound hole and a first external sound hole connected to the first internal sound hole, and
the second sound hole includes a second internal sound hole and a second external sound hole connected to the second internal sound hole,
the microphone unit further comprising a microphone unit body provided with the differential vibrating portion and the first and second internal sound holes, wherein
the first external sound hole and the second external sound hole are provided to extend from the first internal sound hole and the second internal sound hole, respectively, toward the surface intersecting with the main surface of the electronic apparatus.

6. The microphone unit according to claim 5, wherein
the surface intersecting with the main surface of the electronic apparatus is formed to be substantially orthogonal to the main surface,
both an end portion of the first internal sound hole closer to the first external sound hole and an end portion of the second internal sound hole closer to the second external sound hole are provided in a surface of the microphone unit body arranged substantially parallel to the main surface of the electronic apparatus, and
the first external sound hole and the second external sound hole are provided to extend from the first internal sound hole and the second internal sound hole, respectively, toward the surface substantially orthogonal to the main surface of the electronic apparatus by bending or curving.

7. The microphone unit according to claim 6, further comprising a sound hole forming member formed with the first external sound hole and the second external sound hole, wherein
the first external sound hole and the second external sound hole are provided to extend from one of two surfaces, substantially orthogonal to each other, of the sound hole forming member toward the other, so that the first external sound hole and the second external sound hole extend toward the surface intersecting with the main surface of the electronic apparatus.

8. The microphone unit according to claim 5, wherein
the first external sound hole and the second external sound hole have cross-sectional shapes substantially identical to each other in directions substantially orthogonal to traveling directions of sound waves.

9. The microphone unit according to claim 5, wherein
the first external sound hole and the second external sound hole have lengths substantially equal to each other.

10. The microphone unit according to claim 5, wherein
a first end portion of the first external sound hole closer to the surface intersecting with the main surface of the electronic apparatus and a first end portion of the second external sound hole closer to the surface intersecting with the main surface of the electronic apparatus are separately arranged at a distance, which is smaller than a distance between a second end portion of the first external sound hole connected to the first internal sound hole and a second end portion of the second external sound hole connected to the second internal sound hole, from each other.

11. The microphone unit according to claim 6, wherein
the first external sound hole and the second external sound hole respectively are so formed that a vicinity of an end portion of the first external sound hole closer to the first internal sound hole and a vicinity of an end portion of the second external sound hole closer to the second internal sound hole are substantially orthogonal to the surface of the microphone unit body arranged substantially parallel to the main surface of the electronic apparatus, which is provided with the end portion of the first internal sound hole closer to the first external sound hole and the end portion of the second internal sound hole closer to the second external sound hole.

12. The microphone unit according to claim 5, wherein
an end portion of the first internal sound hole closer to the first external sound hole and an end portion of the second internal sound hole closer to the second external sound hole have opening areas larger than opening areas of an end portion of the first external sound hole closer to the first internal sound hole and an end portion of the second external sound hole closer to the second internal sound hole, respectively.

13. The microphone unit according to claim 5, wherein
the first internal sound hole and the second internal sound hole are connected to the first external sound hole and the second external sound hole through a sound leakage prevention member, respectively.

14. The microphone unit according to claim 1, wherein
the main surface of the electronic apparatus is a surface arranged substantially parallel to a main surface of a substrate mounted with the differential vibrating portion.

15. The microphone unit according to claim 1, wherein
the microphone unit is a MEMS microphone.

16. An electronic apparatus comprising:
a differential vibrating portion detecting a sound wave on the basis of a difference between a sound pressure arriving through a first sound hole and a sound pressure arriving through a second sound hole; and
an electronic apparatus housing which houses the differential vibrating portion, wherein
the first sound hole and the second sound hole are provided to extend toward a surface of the electronic apparatus housing intersecting with a main surface of the electronic apparatus housing, and
an end portion of the first sound hole closer to the surface intersecting with the main surface of the electronic apparatus housing and an end portion of the second sound hole closer to the surface intersecting with the main surface of the electronic apparatus housing are so arranged that vertical distances of the end portions from the main surface of the electronic apparatus housing are different from each other.

17. The electronic apparatus according to claim 16, wherein
a first opening and a second opening corresponding to the end portion of the first sound hole and the end portion of the second sound hole, respectively, are formed in the surface intersecting with the main surface of the electronic apparatus housing.

18. The electronic apparatus according to claim 16, wherein
the electronic apparatus housing has a flat rectangular parallelepiped shape, and
the main surface is provided to be substantially orthogonal to a thickness direction of the electronic apparatus housing.

19. The electronic apparatus according to claim 16, wherein
the first sound hole and the second sound hole are provided to extend toward the common surface intersecting with the main surface of the electronic apparatus housing.

20. The electronic apparatus according to claim 16, wherein
the end portion of the first sound hole and the end portion of the second sound hole are spaced from each other on the same axis line substantially orthogonal to the main surface of the electronic apparatus housing.
